(19) United States
(12) Patent Application Publication
(10) Pub. No.: US 2026/0322465 A1
(43) Pub. Date: Oct. 15, 2026

(54) ELECTRONIC DEVICE FOR PERFORMING ANTENNA TUNING AND OPERATION METHOD THEREOF

(71) Applicant: Samsung Electronics Co., Ltd., Suwon-si (KR)

(72) Inventors: Hyungjoon YU, Suwon-si (KR); Taeyang KANG, Suwon-si (KR); Kyusung KIM, Suwon-si (KR); Taeho KIM, Suwon-si (KR); Jongho PARK, Suwon-si (KR); Ji EOM, Suwon-si (KR); Byungkwan LEE, Suwon-si (KR); Sungchan LEE, Suwon-si (KR); Youngkwon LEE, Suwon-si (KR); Jungmin CHO, Suwon-si (KR)

(21) Appl. No.: 19/685,997

(22) Filed: May 22, 2026

Related U.S. Application Data
(63) Continuation of application No. PCT/KR2024/096895, filed on Dec. 13, 2024.

(30) Foreign Application Priority Data
Dec. 28, 2023 (KR) 10-2023-0194144
Mar. 8, 2024 (KR) 10-2024-0033337

(51) Int. Cl. H04B 7/06; H04B 7/08

(52) U.S. Cl. CPC H04B 7/0691; H04B 7/0874

(57) ABSTRACT

An electronic device is provided. The electronic device includes a plurality of antennas, an RF circuit connected to the plurality of antennas, memory, including one or more storage media, storing instructions, and at least one processor, wherein the instructions, when executed by the at least one processor, cause the electronic device to identify a first antenna for communication based on a first frequency and a second antenna for communication based on a second frequency, identify a first event configured for performing tuning based on one tuner included in the RF circuit, based on the first antenna and the second antenna being included in a first antenna group, identify first efficiency data corresponding to each of a plurality of tune codes associated with the first antenna, the first efficiency data being configured for the first event and the first frequency, and identify second efficiency data corresponding to each of a plurality of tune codes associated with the second antenna, the second efficiency data being configured the first event and the second frequency, identify third efficiency data for each of a plurality of tune codes corresponding to the first antenna group, based on the first efficiency data and the second efficiency data, identify an optimal tune code corresponding to the first antenna group, based on the third efficiency data, and control a portion of the one tuner to perform tuning based on the optimal tune code.

### CROSS-REFERENCE TO RELATED APPLICATION(S)

This application is a continuation application, claiming priority under 35 U.S.C. § 365(c), of an International application No. PCT/KR2024/096895, filed on Dec. 13, 2024, which is based on and claims the benefit of a Korean patent application number 10-2023-0194144, filed on Dec. 28, 2023, in the Ministry of Intellectual Property (MOIP), and of a Korean patent application number 10-2024-0033337, filed on Mar. 8, 2024, in the Ministry of Intellectual Property (MOIP), the disclosure of each of which is incorporated by reference herein in its entirety.

### BACKGROUND

### 1. Field

The disclosure relates to an electronic device for changing a transmitting antenna and an operation method thereof.

### 2. Description of Related Art

With recent advancements in mobile communication technology, the widespread use of portable terminals offering diverse functions has led to efforts to develop fifth generation (5G) communication systems to meet the growing demand for wireless data traffic. To achieve high data rates, 5G communication systems are being considered for implementation in higher frequency bands (e.g., 25 to 60 GHz) in addition to the frequency bands used in third generation (3G) and long-term evolution (LTE) communication systems to provide high-speed data transmission.

For example, beamforming, massive multiple-input multiple-output (MIMO), full-dimensional MIMO (FD-MIMO), array antennas, analog beamforming, and large-scale antenna technologies are being discussed in 5G communication systems to mitigate the radio path loss and increase the radio transmission range in the millimeter wave (mmWave) band.

To transmit a signal from an electronic device to a communication network (e.g., a base station), data generated by a processor or communication processor within the electronic device may be processed through an RF circuit (e.g., a radio frequency integrated circuit (RFIC) and/or a radio frequency front end (RFFE)) and then transmitted to the outside of the electronic device via at least one antenna. For example, the RF circuit may include a switch circuit and/or at least one tuner for path configuration corresponding to various operating bands (bands or frequencies) of each of a plurality of antennas. The resonance characteristics of the antenna may be configured based on the tune codes of the tuner. For example, tune codes may be pre-stored in the electronic device for each of various events configured for the electronic device. The electronic device may verify the tune code corresponding to a verified event and control the tuner, based on the verification result.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for changing a transmitting antenna and an operation method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a plurality of antennas, at least one radio frequency (RF) circuit connected to the plurality of antennas, memory, including one or more storage media, storing instructions, and at least one processor communicatively coupled to the at least one RF circuit and the memory, wherein the instructions, when executed by the at least one processor individually or collectively, cause the electronic device to identify a first antenna for communication based on a first frequency and a second antenna for communication based on a second frequency from among the plurality of antennas, identify a first event configured for tuning based on at least one tuner included in the at least one RF circuit, based on the first antenna and the second antenna being included in a first antenna group: identify first efficiency data corresponding to each of a plurality of tune codes associated with the first antenna, the first efficiency data being configured for the first event and the first frequency. and identify second efficiency data corresponding to each of a plurality of tune codes associated with the second antenna, the second efficiency data being configured for the first event and the second frequency, identify third efficiency data for each of a plurality of tune codes corresponding to the first antenna group, based on the first efficiency data and the second efficiency data, identify an optimal tune code corresponding to the first antenna group, based on the third efficiency data, and control at least a portion of the at least one tuner to perform tuning based on the optimal tune code.

In accordance with another aspect of the disclosure, a method of operating an electronic device is provided. The method includes identifying a first antenna for communication based on a first frequency and a second antenna for communication based on a second frequency from among a plurality of antennas of the electronic device, identifying a first event configured for tuning based on at least one tuner included in at least one RF circuit of the electronic device, based on the first antenna and the second antenna being included in a first antenna group: identifying first efficiency data corresponding to each of a plurality of tune codes associated with the first antenna, the first efficiency data being configured for the first event and the first frequency, and identifying second efficiency data corresponding to each of a plurality of tune codes associated with the second antenna, the second efficiency data being configured for the first event and the second frequency, identifying third efficiency data for each of a plurality of tune codes corresponding to the first antenna group, based on the first efficiency data and the second efficiency data, identifying an optimal tune code corresponding to the first antenna group, based on the third efficiency data, and controlling at least a portion of the at least one tuner to perform tuning based on the optimal tune code.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying a first antenna for communication based on a first frequency and a second antenna for communication based on a second frequency from among a plurality of antennas of the electronic device, identifying a first event configured for tuning based on at least one tuner included in at least one RF circuit of the electronic device, based on the first antenna and the second antenna being included in a first antenna group: identifying first efficiency data corresponding to each of a plurality of tune codes associated with the first antenna, the first efficiency data being configured for the first event and the first frequency, and identifying second efficiency data corresponding to each of a plurality of tune codes associated with the second antenna, the second efficiency data being configured for the first event and the second frequency, identifying third efficiency data for each of a plurality of tune codes corresponding to the first antenna group, based on the first efficiency data and the second efficiency data, identifying an optimal tune code corresponding to the first antenna group, based on the third efficiency data, and controlling at least a portion of the at least one tuner to perform tuning based on the optimal tune code.

In accordance with another aspect of the disclosure, an electronic device is provided. The electronic device includes a plurality of antennas, at least one radio frequency (RF) circuit connected to the plurality of antennas, memory, including one or more storage media, storing instructions, and at least one processor communicatively coupled to the at least one RF circuit and the memory, wherein the instructions, when executed by the at least one processor individually or collectively, cause the electronic device to identify a first antenna and a second antenna for communication from the plurality of antennas, identify a first event configured for tuning based on at least one tuner included in the at least one RF circuit, control, based on the first antenna and the second antenna being included in a first antenna group, at least a portion of the at least one tuner to perform tuning based on a first tune code corresponding to the first antenna group, identify to change the second antenna to a third antenna while the first event is maintained, and control, based on the first antenna and the third antenna not being included in one antenna group, the at least one RF circuit to perform tuning based on a second tune code different from the first tune code.

In accordance with another aspect of the disclosure, a method of operating an electronic device is provided. The method includes identifying a first antenna and a second antenna for communication from a plurality of antennas of the electronic device, identifying a first event configured for tuning based on at least one tuner included in at least one RF circuit of the electronic device, controlling, based on the first antenna and the second antenna being included in a first antenna group, at least a portion of the at least one tuner to perform tuning based on a first tune code corresponding to the first antenna group, identifying to change the second antenna to a third antenna while the first event is maintained, and controlling, based on the first antenna and the third antenna not being included in one antenna group, the at least one RF circuit to perform tuning based on a second tune code different from the first tune code.

In accordance with another aspect of the disclosure, an electronic device is provided. The electronic device includes a plurality of antennas, at least one radio frequency (RF) circuit connected to the plurality of antennas, memory, including one or more storage media, storing instructions, and at least one processor communicatively coupled to the at least one RF circuit and the memory, wherein the instructions, when executed by the at least one processor individually or collectively, cause the electronic device to identify a first antenna for first communication based on a first frequency and a second antenna for second communication based on a second frequency from the plurality of antennas, identify a first event configured for tuning based on at least one tuner included in the at least one RF circuit, control, based on the first antenna and the second antenna being included in a first antenna group, at least a portion of the at least one tuner to perform tuning based on a first tune code corresponding to the first antenna group, the first tune code corresponding to at least one first parameter associated with the first communication and at least one second parameter associated with the second communication, identify that the at least one second parameter associated with the second communication has been changed to at least one third parameter while the first event is maintained, and control at least a portion of the at least one tuner to perform tuning based on a second tune code different from the first tune code corresponding to the first antenna group, the second tune code corresponding to at least one first parameter associated with the first communication and at least one third parameter associated with the second communication.

In accordance with another aspect of the disclosure, a method of operating an electronic device is provided. The method includes identifying a first antenna for first communication based on a first frequency and a second antenna for second communication based on a second frequency from a plurality of antennas of the electronic device, identifying a first event configured for tuning based on at least one tuner included in at least one RF circuit of the electronic device, controlling, based on the first antenna and the second antenna being included in a first antenna group, at least a portion of the at least one tuner to perform tuning based on a first tune code corresponding to the first antenna group, the first tune code corresponding to at least one first parameter associated with the first communication and at least one second parameter associated with the second communication, identifying that the at least one second parameter associated with the second communication has been changed to at least one third parameter while the first event is maintained, and controlling at least a portion of the at least one tuner to perform tuning based on a second tune code different from the first tune code corresponding to the first antenna group, the second tune code corresponding to at least one first parameter associated with the first communication and at least one third parameter associated with the second communication.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying a first antenna for first communication based on a first frequency and a second antenna for second communication based on a second frequency from a plurality of antennas of the electronic device, identifying a first event configured for tuning based on at least one tuner included in at least one RF circuit of the electronic device, controlling, based on the first antenna and the second antenna being included in a first antenna group, at least a portion of the at least one tuner to perform tuning based on a first tune code corresponding to the first antenna group, the first tune code corresponding to at least one first parameter associated with the first communication and at least one second parameter associated with the second communication, identifying that the at least one second parameter associated with the second communication has been changed to at least one third parameter while the first event is maintained, and controlling at least a portion of the at least one tuner to perform tuning based on a second tune code different from the first tune code corresponding to the first antenna group, the second tune code corresponding to at least one first parameter associated with the first communication and at least one third parameter associated with the second communication.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a block diagram of an electronic device to support legacy network communication and fifth generation (5G) network communication according to an embodiment of the disclosure;

FIG. 2B is a block diagram of an electronic device to support legacy network communication and 5G network communication according to an embodiment of the disclosure;

FIG. 3A is a block diagram illustrating an electronic device according to an embodiment of the disclosure;

FIG. 3B is a diagram illustrating an electronic device according to an embodiment of the disclosure;

FIGS. 4A, 4B, 4C, and 4D are diagrams illustrating tuners according to various embodiments of the disclosure;

FIG. 5 is a flowchart illustrating an operation method of an electronic device according to an embodiment of the disclosure;

FIG. 6A is a diagram illustrating efficiency data for each antenna according to an embodiment of the disclosure;

FIG. 6B is a diagram illustrating efficiency data for a first antenna according to an embodiment of the disclosure;

FIG. 6C is a diagram illustrating the identification of an optimal tune code according to an embodiment of the disclosure;

FIG. 6D is a diagram illustrating efficiency data according to an embodiment of the disclosure;

FIG. 6E is a flowchart illustrating an operation method of an electronic device according to an embodiment of the disclosure;

FIG. 7 is a flowchart illustrating an operation method of an electronic device according to an embodiment of the disclosure;

FIG. 8A is a flowchart illustrating an operation method of an electronic device according to an embodiment of the disclosure;

FIG. 8B is a flowchart illustrating an operation method of an electronic device according to an embodiment of the disclosure;

FIG. 8C is a flowchart illustrating an operation method of an electronic device according to an embodiment of the disclosure;

FIG. 8D is a flowchart illustrating an operation method of an electronic device according to an embodiment of the disclosure;

FIG. 9A is a flowchart illustrating an operation method of an electronic device according to an embodiment of the disclosure;

FIG. 9B is a flowchart illustrating an operation method of an electronic device according to an embodiment of the disclosure;

FIGS. 9C, 9D, and 9E are diagrams illustrating changes in the form factor of an electronic device according to various embodiments of the disclosure;

FIG. 10A illustrates a flowchart illustrating an operation method of an electronic device according to an embodiment of the disclosure;

FIG. 10B illustrates a flowchart illustrating an operation method of an electronic device according to an embodiment of the disclosure;

FIG. 11 illustrates a flowchart illustrating an operation method of an electronic device according to an embodiment of the disclosure;

FIG. 12 illustrates a flowchart illustrating an operation method of an electronic device according to an embodiment of the disclosure; and

FIG. 13 illustrates a flowchart illustrating an operation method of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

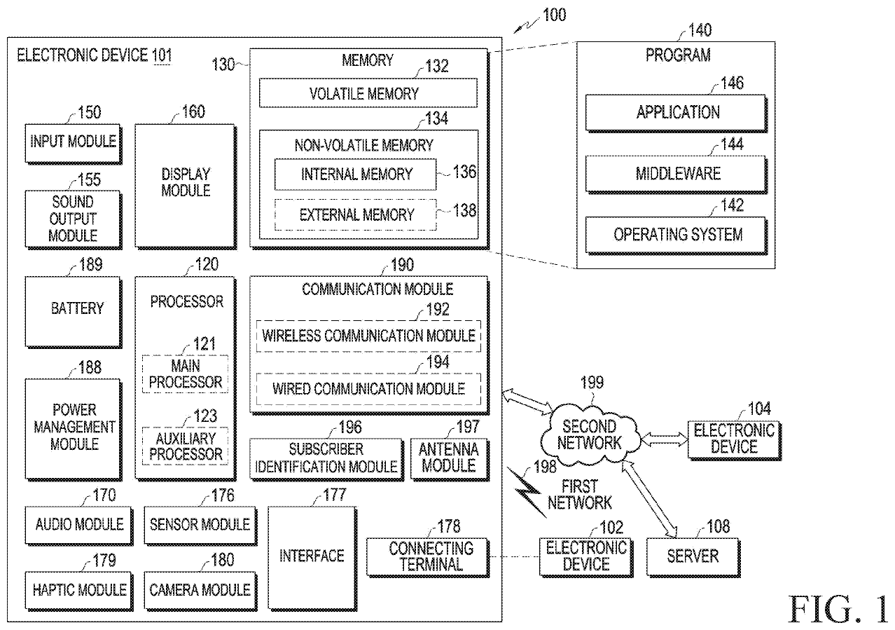

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

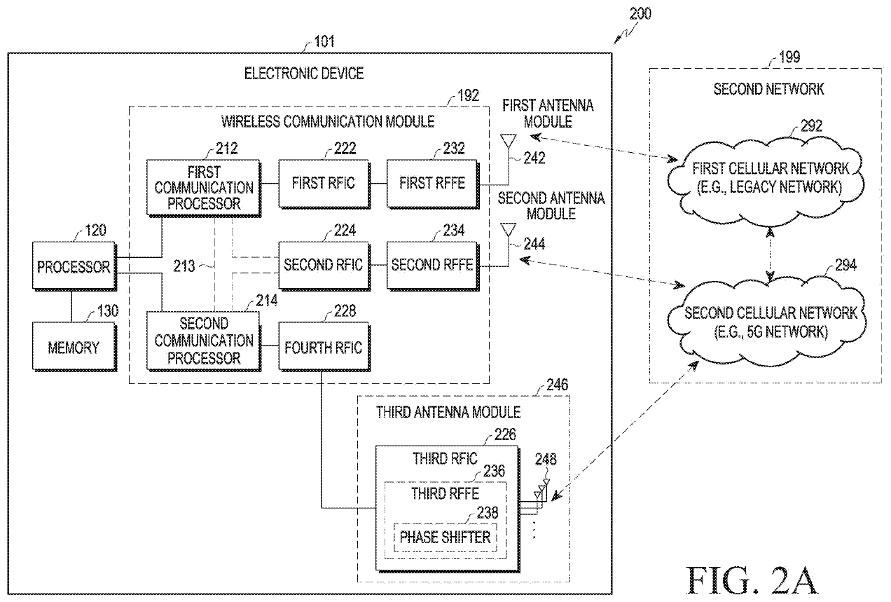

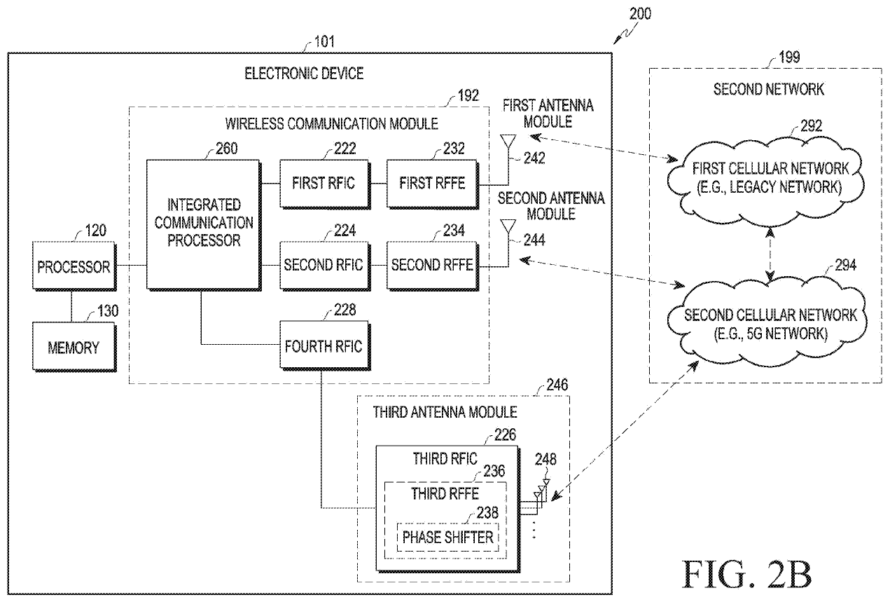

FIG. 2A is a block diagram 200 of an electronic device to support legacy network communication and 5G network communication according to an embodiment of the disclosure.

Referring to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120 and memory 130. The second network 199 may include a first cellular network 292 and a second cellular network 294. According to another embodiment of the disclosure, the electronic device 101 may further include at least one of the components described in FIG. 1, and the second network 199 may further include at least one other network. According to one embodiment of the disclosure, the first communication processor 212, the second communication processor 214, the first RFIC 222, the second RFIC 224, the fourth RFIC 228, the first RFFE 232, and the second RFFE 234 may form at least a portion of a wireless communication module 192. According to another embodiment of the disclosure, the fourth RFIC 228 may be omitted or included as a part of the third RFIC 226.

The first communication processor 212 may establish a communication channel in a band to be used for wireless communication with the first cellular network 292, and support legacy network communication through the established communication channel. According to an embodiment of the disclosure, the first cellular network may be a legacy network including a second generation (2G), 3G, 4G, or long-term evolution (LTE) network. The second communication processor 214 may establish a communication channel corresponding to a designated band (e.g., approximately 6 GHz to approximately 60 GHz) among the bands to be used for wireless communication with the second cellular network 294, and support 5G network communication through the established communication channel. According to an embodiment of the disclosure, the second cellular network 294 may be a 5G network defined in the 3GPP. Additionally, according to an embodiment of the disclosure, the first communication processor 212 or the second communication processor 214 may establish a communication channel corresponding to another designated band (e.g., approximately 6 GHz or less) among the bands to be used for wireless communication with the second cellular network 294, and support 5G network communication through the established communication channel.

The first communication processor 212 may transmit and receive data to and from the second communication processor 214. For example, data classified to be transmitted through the second cellular network 294 may be changed to be transmitted through the first cellular network 292. In this case, the first communication processor 212 may receive transmission data from the second communication processor 214. For example, the first communication processor 212 may transmit and receive data to and from the second communication processor 214 through an inter-processor interface 213. The inter-processor interface 213 may be implemented as, for example, a universal asynchronous receiver/transmitter (UART) (e.g., high speed-UART (HS-UART)) or a peripheral component interconnect bus express (PCIe) interface, but there is no limitation on the type thereof. Alternatively, the first communication processor 212 and the second communication processor 214 may exchange control information and packet data information using, for example, shared memory. The first communication processor 212 may transmit and receive various information, such as sensing information, information about output intensity, and resource block (RB) allocation information, to and from the second communication processor 214.

Depending on the implementation, the first communication processor 212 may not be directly connected to the second communication processor 214. In this case, the first communication processor 212 may transmit and receive data to and from the second communication processor 214 through the processor 120 (e.g., an application processor). For example, the first communication processor 212 and the second communication processor 214 may transmit and receive data to and from each other through the processor 120 (e.g., the application processor) and an HS-UART interface or a PCIe interface, but there is no limitation on the type of interface. Alternatively, the first communication processor 212 and the second communication processor 214 may exchange control information and packet data information using the processor 120 (e.g., the application processor) and shared memory.

FIG. 2B is a block diagram of an electronic device to support legacy network communication and 5G network communication according to an embodiment of the disclosure.

Referring to FIG. 2B, according to an embodiment of the disclosure, the first communication processor 212 and the second communication processor 214 may be implemented in a single chip or a single package. According to an embodiment of the disclosure, the first communication processor 212 or the second communication processor 214 may be formed in a single chip or a single package with the processor 120, the auxiliary processor 123, or the communication module 190. For example, as shown in FIG. 2B, an integrated communication processor 260 may support all functions for communication with the first cellular network 292 and the second cellular network 294.

As described above, at least one of the processor 120, the first communication processor 212, the second communication processor 214, or the integrated communication processor 260 may be implemented as a single chip or a single package. In this case, the single chip or single package may include memory (or storage means) for storing instructions that cause the execution of at least some of the operations performed according to an embodiment of the disclosure, and a processing circuit (or an arithmetic circuit, the name of which is not limited) for executing the instructions.

When transmitting, the first RFIC 222 may convert a baseband signal generated by the first communication processor 212 into a radio frequency (RF) signal of about 700 MHz to about 3 GHz used in the first cellular network 292 (e.g., a legacy network). When receiving, an RF signal may be obtained from a first network 292 (e.g., a legacy network) via an antenna (e.g., a first antenna module 242) and preprocessed through an RFFE (e.g., the first RFFE 232). The first RFIC 222 may convert the preprocessed RF signal into a baseband signal so that it may be processed by the first communication processor 212.

When transmitting, the second RFIC 224 may convert the baseband signal generated by the first communication processor 212 or the second communication processor 214 into an RF signal of a Sub6 band (e.g., about 6 GHz or less) (hereinafter, a 5G Sub6 RF signal) used for the second cellular network 294 (e.g., a 5G network). When receiving, a 5G Sub6 RF signal may be obtained from the second cellular network 294 (e.g., a 5G network) via an antenna (e.g., a second antenna module 244), and preprocessed through an RFFE (e.g., the second RFFE 234). The second RFIC 224 may convert the preprocessed 5G Sub6 RF signal into a baseband signal so that it may be processed by a corresponding communication processor among the first communication processor 212 or the second communication processor 214.

The third RFIC 226 may convert the baseband signal generated by the second communication processor 214 into an RF signal of a 5G Above6 band (e.g., about 6 GHz to about 60 GHz) (hereinafter, a 5G Above6 RF signal) to be used in the second cellular network 294 (e.g., a 5G network). When receiving, a 5G Above6 RF signal may be obtained from the second cellular network 294 (e.g., a 5G network) via an antenna (e.g., the antenna 248) and preprocessed through a third RFFE 236. The third RFIC 226 may convert the preprocessed 5G Above6 RF signal into a baseband signal so as to be processed by the second communication processor 214. In an embodiment of the disclosure, the third RFFE 236 may be formed as a part of the third RFIC 226.

According to an embodiment of the disclosure, the electronic device 101 may include a fourth RFIC 228 separately from or at least as a part of the third RFIC 226. In this case, the fourth RFIC 228 may convert the baseband signal generated by the second communication processor 214 into an RF signal (hereinafter, “IF signal”) of an intermediate frequency band (e.g., approximately 9 GHz to approximately 11 GHz) and then transmit the IF signal to the third RFIC 226. The third RFIC 226 may convert the IF signal into a 5G Above6 RF signal. When receiving, the 5G Above6 RF signal may be received from the second cellular network 294 (e.g., a 5G network) via an antenna (e.g., the antenna 248) and converted into an IF signal by the third RFIC 226. The fourth RFIC 228 may convert the IF signal into a baseband signal so that the second communication processor 214 may process it.

According to an embodiment of the disclosure, the first RFIC 222 and the second RFIC 224 may be implemented as at least a portion of a single chip or a single package. According to an embodiment of the disclosure, when the first RFIC 222 and the second RFIC 224 are implemented as a single chip or a single package in FIG. 2A or 2B, they may be implemented as an integrated RFIC. In this case, the integrated RFIC may be connected to the first RFFE 232 and the second RFFE 234, and may convert a baseband signal into a signal of a band supported by the first RFFE 232 and/or the second RFFE 234, and transmit the converted signal to one of the first RFFE 232 and the second RFFE 234. According to an embodiment of the disclosure, the first RFFE 232 and the second RFFE 234 may be implemented as at least a portion of a single chip or a single package. According to an embodiment of the disclosure, at least one of the first antenna module 242 or the second antenna module 244 may be omitted or combined with another antenna module to process RF signals of multiple bands corresponding thereto.

According to an embodiment of the disclosure, the third RFIC 226 and the antenna 248 may be arranged on the same substrate to form a third antenna module 246. For example, the wireless communication module 192 or the processor 120 may be disposed on a first substrate (e.g., a main PCB). In this case, the third RFIC 226 may be disposed on a portion (e.g., the lower surface) of a second substrate (e.g., a sub PCB) separate from the first substrate, and the antenna 248 may be disposed on another portion (e.g., the upper surface), thereby forming the third antenna module 246. By arranging the third RFIC 226 and the antenna 248 on the same substrate, it is possible to reduce the length of the transmission line between them. This may reduce, for example, the loss (e.g., attenuation) of signals in the high-frequency band (e.g., approximately 6 GHz to approximately 60 GHz) used for 5G network communications due to the transmission line. Therefore, the electronic device 101 may improve the quality or speed of communication with the second network 294 (e.g., the 5G network).

According to an embodiment of the disclosure, the antenna 248 may be formed as an antenna array including a plurality of antenna elements that may be used for beamforming. In this case, the third RFIC 226 may, for example, include, as a part of the third RFFE 236, a plurality of phase shifters 238 corresponding to the plurality of antenna elements. When transmitting, each of the plurality of phase shifters 238 may shift the phase of a 5G Above6 RF signal to be transmitted to an external element (e.g., a base station in a 5G network) of the electronic device 101 via a corresponding antenna element. When receiving, each of the plurality of phase shifters 238 may shift the phase of a 5G Above6 RF signal received from the external element via a corresponding antenna element to the same or substantially the same phase. This enables transmission or reception through beamforming between the electronic device 101 and the external element.

The second cellular network 294 (e.g., the 5G network) may operate independently (e.g., stand-alone (SA)) or in conjunction with (e.g., non-stand alone (NSA)) the first cellular network 292 (e.g., the legacy network). For example, the 5G network may only have an access network (e.g., a 5G radio access network (RAN) or next generation RAN (NG RAN)) and no core network (e.g., next generation core (NGC)). In this case, the electronic device 101 may access the access network of the 5G network, and then access an external network (e.g., the Internet) under the control of a core network (e.g., evolved packed core (EPC)) of the legacy network. Protocol information (e.g., LTE protocol information) for communication with the legacy network or protocol information (e.g., new-radio (NR) protocol information) for communication with the 5G network may be stored in the memory 230 and accessed by other components (e.g., the processor 120, the first communication processor 212, or the second communication processor 214).

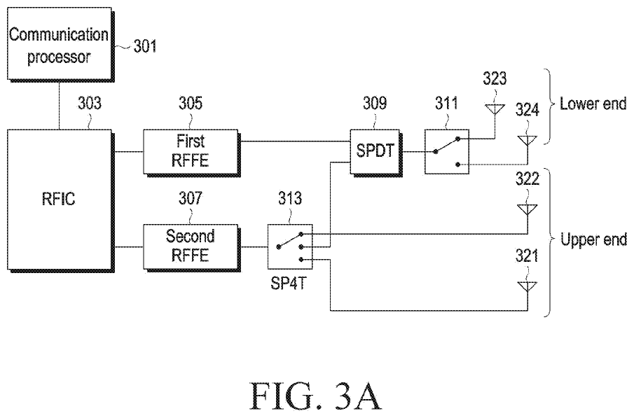

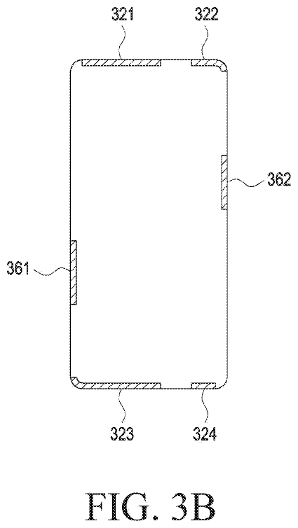

FIG. 3A is a block diagram illustrating an electronic device according to an embodiment of the disclosure. The embodiment in FIG. 3A will be described with reference to FIG. 3B. FIG. 3B is a diagram illustrating an electronic device according to an embodiment of the disclosure.

Referring to FIGS. 3A and 3B, according to an embodiment of the disclosure, a communication processor 301 (e.g., at least one of the first communication processor 212, the second communication processor 214, or the integrated communication processor 260) may transmit and/or receive signals to and/or from an RFIC 303 (e.g., at least one of the first RFIC 222, the second RFIC 224, the third RFIC 226, or the fourth RFIC 228). The RFIC 303 may process at least one RF signal associated with at least one RF path. Here, the RF path may include, for example, at least one piece of hardware (e.g., at least one of an RFIC, an RFFE, or an antenna) for transmitting RF signals. For example, the RFIC 303 may receive at least one signal from the communication processor 301 and generate at least one RF signal. Although the RFIC 303 is illustrated as a single module in the example of FIG. 3A, this is merely exemplary, and those skilled in the art will appreciate that there is no limitation on the number of modules in which the RFIC 303 may be implemented.

According to an embodiment of the disclosure, the RFIC 303 may provide at least one RF signal to the first RFFE 305 and/or the second RFFE 307. The first RFFE 305 and/or the second RFFE 307 may process (e.g., amplify) the received RF signal and provide it. The communication processor 301 may also determine the amplification level of the RFFEs 305 and 307, based on the maximum transmission power level and/or transmission power determined as described above. Although not shown, the amplification levels of the RFFEs 305 and 307 may be controlled based on an average power tracking (APT) module and/or an envelope tracking (ET) module. According to an embodiment of the disclosure, a single RFFE may process a plurality of RF signals.

According to an embodiment of the disclosure, the first RFFE 305 may be connected to a single pole double throw (SPDT) switch 309, and the output end of the SPDT switch 309 may be connected to a switch 311. The switch 311 may be configured to selectively connect the output end of the SPDT switch 309 to either a third antenna 323 or a fourth antenna 324. The second RFFE 307 may be connected to the switch 313. The switch 313 may be configured to selectively connect the output end of the second RFFE 307 to any one of the SPDT switch 309, the first antenna 321, or the second antenna 322. Meanwhile, each of the antennas 321, 322, 323, 324, 361, and 362 may be disposed inside the housing and/or may be disposed on a portion of the housing. For example, they may be disposed on the outer surface of the housing of the electronic device 101, but there is no limitation thereto. In one example, as shown in FIG. 3B, the antennas 323 and 324 may be disposed on one side (e.g., the bottom) of the housing of the electronic device 101, and the antennas 321 and 322 may be disposed on the other side (e.g., the top) of the housing of the electronic device 101, but this is exemplary.

For example, the electronic device 101 may identify whether the plurality of antennas are included in a single antenna group. For example, the electronic device 101 may identify whether the first antenna 321 and the second antenna 322 are included in a single antenna group. The electronic device 101 may store and/or manage antenna group-related information as antenna information for each of the antennas 321, 322, 323, 324, 325, and 326. For example, Table 1 may be an example of antenna group-related information for each of the antennas 321, 322, 323, 324, 325, and 326.

TABLE 1

| Antennas | Antenna group-related information |
|---|---|
| First antenna 321 | First antenna group |
| Second antenna 322 | First antenna group |
| Third antenna 323 | Second antenna group |
| Fourth antenna 324 | Second antenna group |
| Fifth antenna 325 | First antenna group and Second |
| | antenna group |
| Sixth antenna 326 | First antenna group and Second |
| | antenna group |

For example, the electronic device 101, based on the antenna group-related information as antenna information for each of the antennas 321, 322, 323, 324, 325, 326 as shown in Table 1, may identify whether a plurality of antennas to be used for communication are included in a single antenna group. Meanwhile, the fifth antenna 325 and the sixth antenna 326 may be included in the first antenna group or in the second antenna group, and thus may be referred to as shared antennas. For example, if the distance between the antennas is equal to or less than a threshold distance, the antennas may be configured as a single group. The threshold distance indicates a distance at which interference in radiation performance between antennas is prevented, and may be experimentally determined, but there are no restrictions on how it is determined. For example, there are no restrictions on the reference point for each antenna used to define the distance between antennas. For example, the reference point may be configured in various ways, such as a point where the maximum radiation signal is generated among the antennas, the center of mass of the antenna, or a point at one end of the antenna, and there are no restrictions on how it is configured. Meanwhile, the distance between the antennas is a parameter for configuring an antenna group, and, in addition to the distance, the shape of the antenna, the extending direction of the antenna, the type of the antenna, and/or the frequency characteristics of the antenna may alternatively and/or additionally be used for configuring the antenna group. These parameters may also be referred to as parameters for expressing antenna isolation characteristics. Meanwhile, an electronic device 101 with a changeable form factor (or it may be referred to as external appearance or housing shape) may include a plurality of pieces of antenna group-related information, as shown in Table 1, for each form factor (or external appearance or housing shape). Alternatively, the electronic device 101 may identify the distance between antennas (or, alternatively and/or additionally, the shape of the antenna, the extension direction of the antenna, the type of the antenna, and/or the frequency characteristics of the antenna) and, based on the identification result, identify whether the antennas are included in the same antenna group. For example, the electronic device 101 may identify the distance between the first antenna 321 and the second antenna 322 and, based on the identified distance being less than or equal to a threshold distance, identify that the first antenna 321 and the second antenna 322 are included in the same antenna group. Meanwhile, there is no limitation on the method for identifying whether the plurality of antennas are included in the same antenna group.

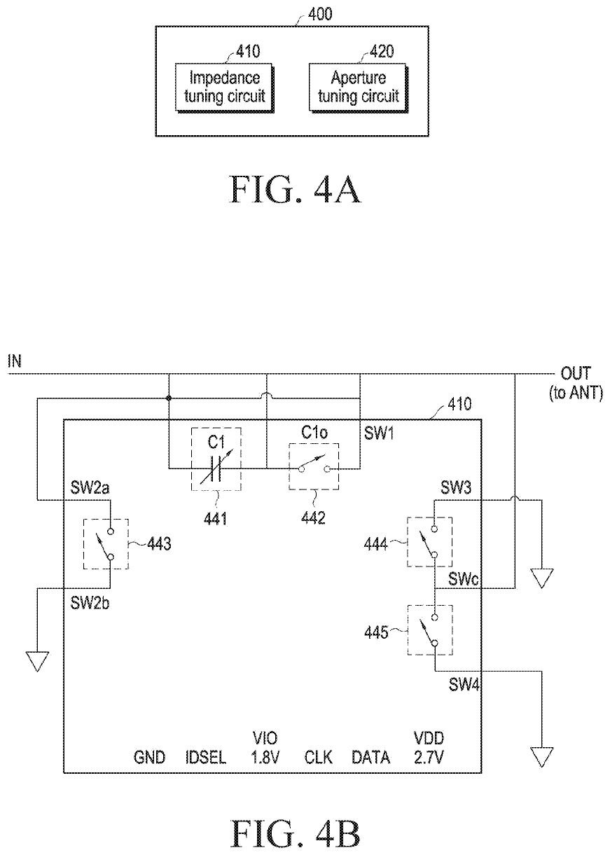

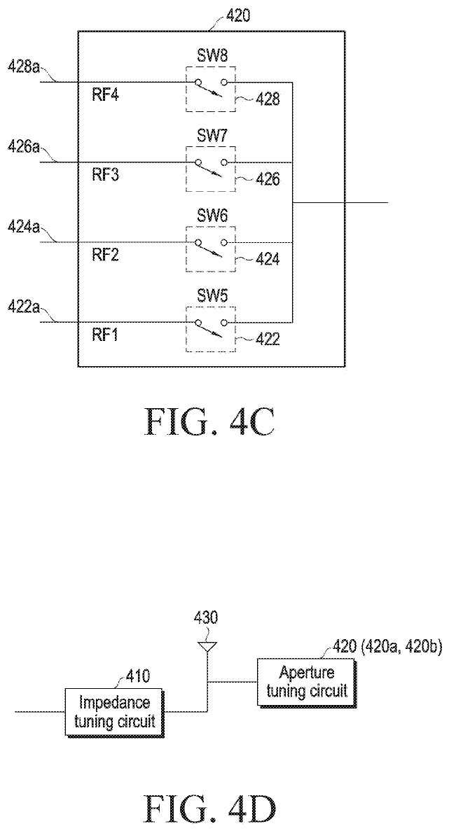

FIGS. 4A, 4B, 4C, and 4D are diagrams illustrating tuners according to various embodiments of the disclosure.

Referring to FIG. 4A, a tuner 400 according to an embodiment may include at least one impedance tuning circuit 410 and/or at least one aperture tuning circuit 420. The tuner 400 may be directly connected to antennas (e.g., the antennas 321, 322, 323, 324, 325, and 326 in FIG. 3B) or may be connected thereto through other elements, and those skilled in the art will understand that there are no limitations on the location of the point where the tuner 400 is connected and/or the number of tuners 400. For example, at least one tuner may be connected to one antenna group, and at least one other tuner may be connected to another antenna group. The impedance tuning circuit 410 may be configured to perform impedance matching with a network under the control of at least one processor (e.g., the processor 120, the communication processors 212 and 214, and/or the integrated communication processor 260). The aperture tuning circuit 420 may change the antenna structure by turning on and off a switch under the control of at least one processor. FIG. 4B illustrates a circuit diagram illustrating the impedance tuning circuit 410. FIG. 4C illustrates an circuit diagram illustrating the aperture tuning circuit 420. The impedance tuning circuit 410 in FIG. 4B may be used as an aperture tuning circuit, and the aperture tuning circuit 420 in FIG. 4C may be used as an impedance tuning circuit. As shown in FIG. 4A, in one example, the impedance tuning circuit 410 may be connected to the RFFE and its duplexer, but this is merely exemplary. For example, the impedance tuning circuit 410 may be connected to the antenna 430, and a first aperture tuning circuit 420a and a second aperture tuning circuit 420b may be connected to the power rail connecting the impedance tuning circuit 410 and the antenna 430. The electronic device 101 (e.g., the communication processor 260) may control the tuner, based on a tune code corresponding to an event that has occurred. For example, when utilizing a plurality of antennas, the electronic device 101 may identify an optimal tune code corresponding to an antenna group, based on the plurality of antennas being included in the same antenna group, which will be described later.

According to an embodiment of the disclosure, a switch (e.g., a routing switch) and/or a tuner may be used to configure a plurality of bands (frequencies) in at least one antenna of the electronic device 101. For example, if configuration of the tune code (e.g., a register) of the switch and/or tuner is changed, the resonance characteristics of the antenna may change, thereby altering the frequency performance of the antenna. According to an embodiment of the disclosure, antenna tune code values capable of optimizing radiation performance at antenna operating frequencies (or bands) used for various events (or user interactions) and/or communication mode-related information (e.g., carrier aggregation (CA) and/or multi-input multi-output (MIMO), but not limited thereto) may be stored in the form of a lookup table in the electronic device 101 and/or derived therefrom. If the tune codes are stored based on the lookup table, the electronic device 101 may also perform control based on the tune code corresponding to the event.

Referring to FIG. 4B, the impedance tuning circuit 410 according to various embodiment may include at least one variable capacitor 441, a first switch 442, a second switch 443, a third switch 444, and/or a fourth switch 445. The number of variable capacitors 441, first switches 442, second switches 443, third switches 444, and fourth switches 445 may vary. At least one variable capacitor 441, first switch 442, second switch 443, third switch 444, and fourth switch 445 may be implemented on a single chip, but there is no limitation. The variable capacitor 441 may have, for example, 16 values (e.g., capacitance values). The number of capacitance values of the variable capacitor 441 may vary. In this case, the impedance tuning circuit 410 may have a total of 256 (16 (possible values that the variable capacitor may have)×16 (possible cases of combinations of 4 switches)) configurable values (e.g., impedance values). The variable capacitor 441 may be electrically connected to the first switch 442. One end of the second switch 443, the third switch 444, and/or the fourth switch 445 may be grounded.

Referring to FIG. 4C, the aperture tuning circuit 420 according to various embodiment may include a fifth switch 422, a sixth switch 424, a seventh switch 426, and/or an eighth switch 428. The fifth switch 422 may be connected to a first terminal (RF1) 422A. The sixth switch 424 may be connected to a second terminal (RF2) 424A. The seventh switch 426 may be connected to third terminal (RF3) 426A. The eighth switch 428 may be connected to a fourth terminal (RF4) 428A. The number of switches included in the aperture tuning circuit 420 may vary. The fifth switch 422, the sixth switch 424, the seventh switch 426, and/or the eighth switch 428 may be implemented on a single chip. The aperture tuning circuit 420 may have a total of 16 possible combinations of on/off states of the switches (e.g., the fifth switch 422, the sixth switch 424, the seventh switch 426, and the eighth switch 428). Accordingly, the tuning circuit may have a total of 4096 antenna configurations (e.g., 256×16).

As illustrated in FIGS. 4B and 4C, the resonance characteristics of the connected antenna (e.g., the resonant frequency of the antenna) may be changed by changing the on/off states of the switches included in the tuner 400 (e.g., the impedance tuning circuit 410 and/or the aperture tuning circuit 420). The values corresponding to the combination of the on/off states of the switches may be referred to as tune codes (or antenna configurations or tuner configurations).

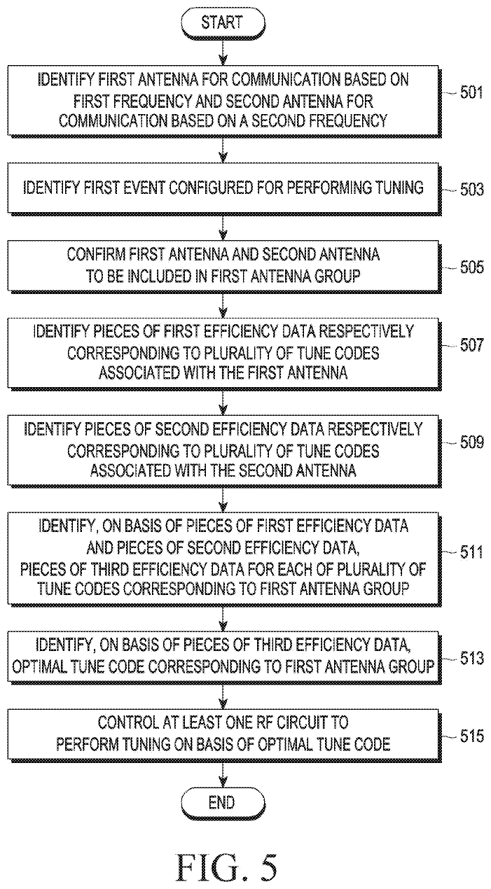

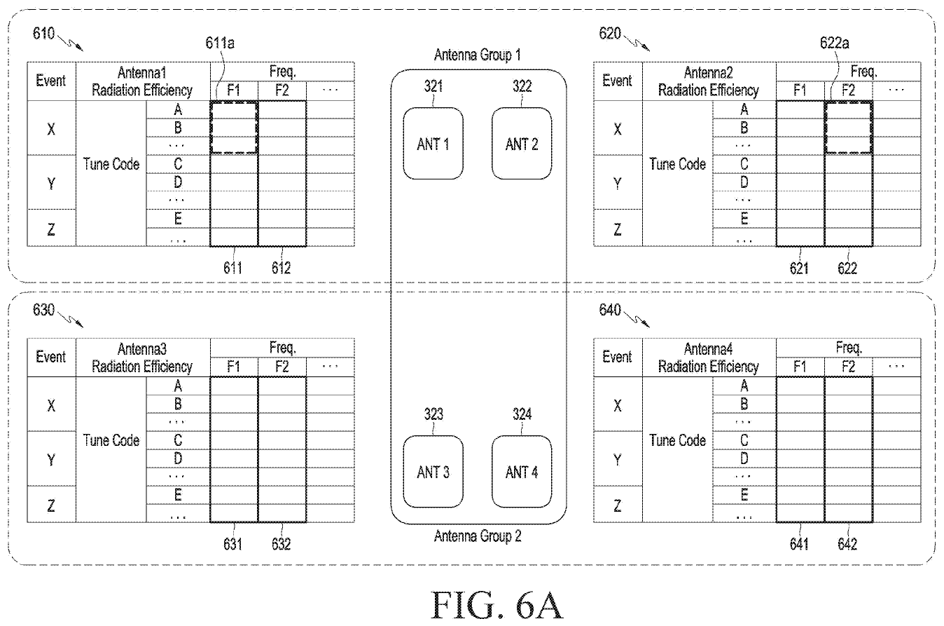

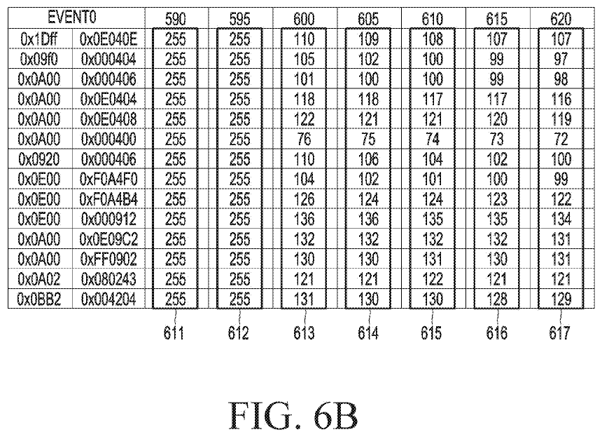

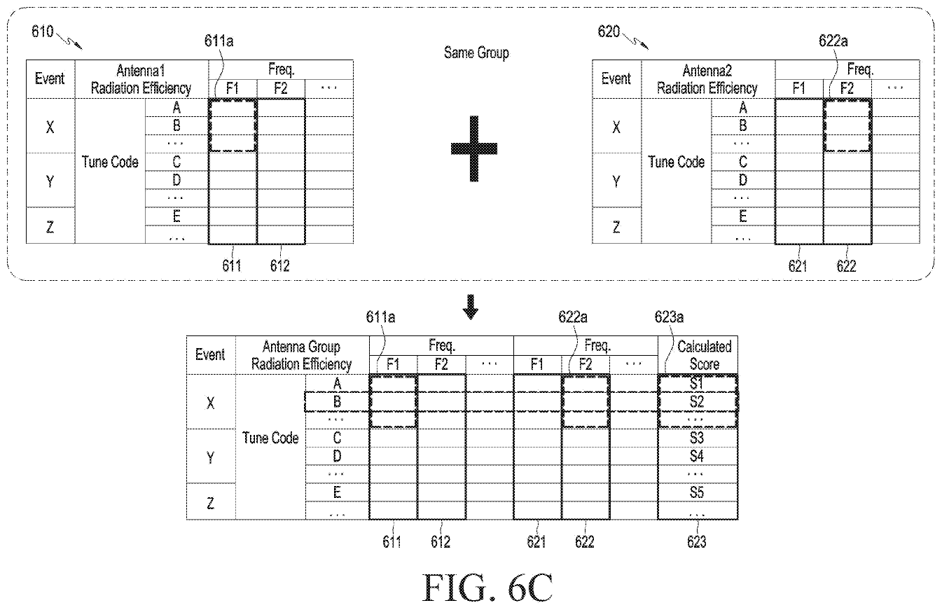

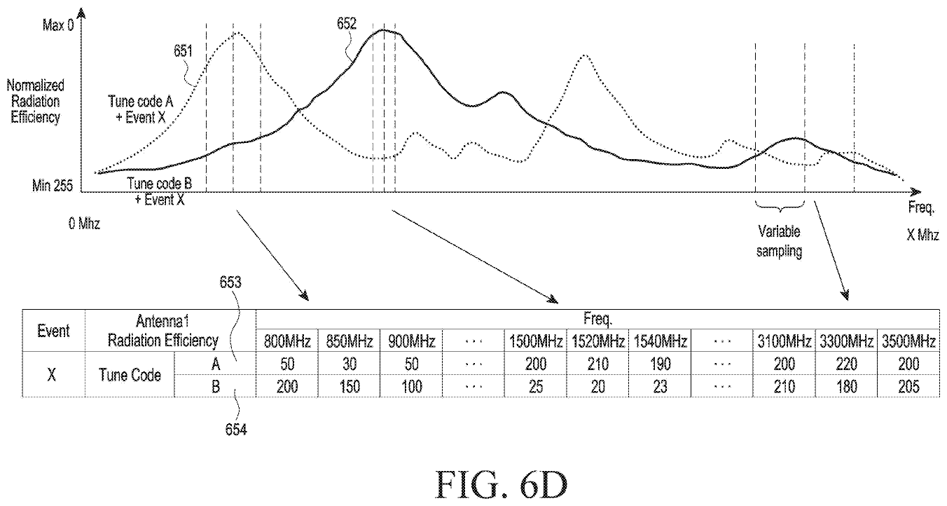

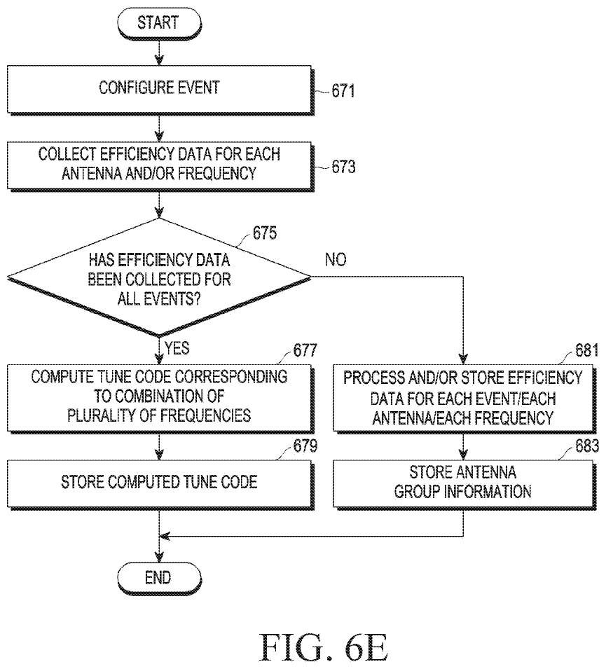

FIG. 5 illustrates a flowchart illustrating an operation method of an electronic device according to an embodiment of the disclosure. The embodiment of FIG. 5 will be described with reference to FIGS. 6A, 6B, 6C, and 6D. FIG. 6A is a diagram illustrating efficiency data for each antenna according to an embodiment of the disclosure. FIG. 6B is a diagram illustrating efficiency data for a first antenna according to an embodiment of the disclosure. FIG. 6C is a diagram illustrating an identification of an optimal tune code according to an embodiment of the disclosure. FIG. 6D is a diagram illustrating efficiency data according to an embodiment of the disclosure.

Referring to FIG. 5, according to an embodiment of the disclosure, the electronic device 101, in operation 501, may identify a first antenna 321 for communication based on a first frequency and a second antenna 322 for communication based on a second frequency. For example, the electronic device 101 may identify a first antenna 321 as the antenna preconfigured corresponding to the first frequency (or a first operating band). The first antenna 321 may be preconfigured corresponding to, for example, the first frequency or a frequency range (e.g., a low band, a mid band, a high band, or an ultra-high band, but not limited thereto) including the first frequency. The electronic device 101 may identify a second antenna 322 as the antenna preconfigured corresponding to the second frequency (or a second operating band). The second antenna 322 may be preconfigured corresponding to, for example, the second frequency or a frequency range including the second frequency. For example, when a plurality of antennas are configured corresponding to a frequency range, the electronic device 101 may identify the first antenna 321 and/or the second antenna 322, based on a specified rule. For example, the first antenna 321 and/or the second antenna 322 may be configured as a default antenna (or preferred antenna). Meanwhile, those skilled in the art may understand that the first antenna 321 and/or the second antenna 322 may also be identified based on antenna change conditions (e.g., conditions based on ASDiv and/or conditions based on antenna hopping). Meanwhile, there is no limitation on the method by which the first antenna 321 and/or the second antenna 322 are identified. The electronic device 101 may utilize a plurality of antennas 321 and 322 for carrier aggregation (CA), dual connectivity (DC), dual SIM, and/or measurement of reception strength for a serving cell and a neighbor cell, but there is no limitation on the purpose and/or method for utilizing the plurality of antennas 321 and 322. Here, those skilled in the art may understand that measurement of reception strength for a neighbor cell may also be expressed as communication.

According to an embodiment of the disclosure, in operation 503, the electronic device 101 may identify a first event configured for tuning based on at least one tuner (e.g., the tuner 400 in FIG. 4A) included in at least one RF circuit. The first event may be, for example, one of a free space event, a universal serial bus (USB) connection event, an ear jack connection event, a travel adapter (TA) connection event, or a grip detection event, but those skilled in the art may understand that this is exemplary and that there is no limitation on the type and/or number of events associated with the tune code.

According to an embodiment of the disclosure, the electronic device 101, in operation 505, may identify that the first antenna 321 and the second antenna 322 are included in a first antenna group. For example, the electronic device 101 may identify that the first antenna 321 and the second antenna 322 are included in the first antenna group, based on antenna-related information of the first antenna 321 and the second antenna 322, such as antenna group-related information as shown in Table 1. Alternatively, the electronic device 101 may identify that the first antenna 321 and the second antenna 322 are included in the first antenna group, based on the distance between the first antenna 321 and the second antenna 322. For example, the electronic device 101 may identify that the first antenna 321 and the second antenna 322 are included in one antenna group, based on the distance between the first antenna 321 and the second antenna 322 being less than or equal to a threshold distance, but there is no limitation on the method for determining whether both the antennas 321 and 322 are included in one antenna group.

Referring to FIG. 6A, according to an embodiment of the disclosure, in operation 507, the electronic device 101 may identify first efficiency data 611a corresponding to the identified first event (e.g., X) and first frequency (e.g., F1) from among a plurality of tune codes A, B, C, . . . , D, . . . , E . . . associated with the first antenna 321. The efficiency data 610 is, for example, data associated with tune codes and/or frequency-specific radiation performance (passive) for the switch and/or tuner components included in at least one antenna group, and, for example, may be raw data or data converted from raw data, but there is no limitation. For example, the efficiency data 610 may be configured to correspond to a plurality of frequencies F1, F2, . . . . The efficiency data 610 associated with the first antenna 321 may include efficiency data 611 and 612 for each tune code, which corresponds to a plurality of frequencies F1 and F2, respectively. For example, the efficiency data 610 may be configured to correspond to a plurality of events X, Y, and Z. The electronic device 101 may identify first efficiency data 611A corresponding to a first event (e.g., X) and a first frequency (e.g., F1) from among the efficiency data 610.

Referring to FIG. 6B, in the electronic device 101, the efficiency data 610 may include multiple pieces of efficiency data 611 to 617 corresponding to a plurality of frequencies (590 MHz to 620 MHz) for one event (e.g., EVENT 0 in FIG. 6B) among a plurality of events. Each of the multiple pieces of efficiency data 611 to 617 may be configured to have one of the values, for example, 0 to 255 in FIG. 6B, but this is exemplary and the range of values is not limited. In addition, although the gap between frequencies is configured to 5 MHz, the gap is also not limited. For example, the gap between frequencies may be adjusted depending on the variation in efficiency data and/or may be configured differently depending on the frequency range. For example, in a range where the difference in efficiency data between frequencies is relatively large, the gap may be configured to be relatively small, but there is no limitation. The efficiency data may be configured based on, for example, total radiation efficiency, normalized radiation efficiency, and/or reflection coefficient, but there is no limitation on how the efficiency data is configured. The efficiency data may be experimentally verified, for example, for a model of the electronic device 101, provided to the electronic device 101 for storage and/or management, but there is no limitation on how the efficiency data is obtained.

According to an embodiment of the disclosure, the electronic device 101, in operation 509, may identify, for example, second efficiency data 622A corresponding to the identified first event (e.g., X) and second frequency (e.g., F2) among the plurality of tune codes A, B, C, . . . , D, . . . , E . . . associated with the second antenna 322 as shown in FIG. 6A. For example, the efficiency data 620 may be configured to correspond to the plurality of frequencies F1, F2, . . . . The efficiency data 610 associated with the second antenna 322 may include multiple pieces of efficiency data 621 and 622 for each tune code, which correspond to the plurality of frequencies F1 and F2, respectively. For example, the efficiency data 620 may be configured to correspond to the plurality of events X, Y, and Z. The electronic device 101 may identify second efficiency data 622A corresponding to the first event (e.g., X) and the second frequency (e.g., F2) from among the efficiency data 620. Meanwhile, the electronic device 101 may store and/or manage efficiency data 630 corresponding to the third antenna 323 and efficiency data 640 corresponding to the fourth antenna 324. The efficiency data 630 corresponding to the third antenna 323 may include multiple pieces of efficiency data 631 and 632 for each tune code, which correspond to the plurality of frequencies F1 and F2, respectively. The efficiency data 640 corresponding to the fourth antenna 324 may include multiple pieces of efficiency data 641 and 642 for each tune code, which correspond to the plurality of frequencies F1 and F2, respectively. Meanwhile, although, in the example of FIG. 6A, the efficiency data 610, 620, 630, and 640 respectively corresponding to the antennas 321, 322, 323, and 324 is illustrated as being configured for the same events X, Y, and Z and/or the same frequencies F1, F2, . . . , this is exemplary, and at least some of the events and/or at least some of the frequencies may be different among the antennas.

Referring to FIG. 6C, according to an embodiment of the disclosure, in operation 511, the electronic device 101 may identify third efficiency data 623A for each of a plurality of tune codes, which corresponds to the first antenna group associated with the first event (e.g., X), based on the first efficiency data 611A and the second efficiency data 622A. For example, the electronic device 101 may identify the third efficiency data 623A by applying a specified calculation method to the first efficiency data 611A and the second efficiency data 622A. For example, the electronic device 101 may identify the third efficiency data 623A, based on the weight sum of the first efficiency data 611A and the second efficiency data 622A, but there is no limitation on the identification method, and the weight assignment method will be described later. In operation 513, the electronic device 101 may identify an optimal tune code (e.g., B) corresponding to the first antenna group, based on the third efficiency data 623A. For example, the electronic device 101 may identify the maximum value (e.g., S2) among the third efficiency data 623A as the optimal tune code (e.g., B) corresponding to the first antenna group. In operation 515, the electronic device 101 may control at least one RF circuit to perform tuning, based on the optimal tune code (e.g., B).

According to an embodiment of the disclosure, the electronic device 101 may not pre-store tune codes for all antennas, frequencies, and events. In this case, even though the electronic device 101 must utilize a plurality of antennas, there is a possibility that the resonance characteristics of other antennas may deteriorate due to the use of a tune code optimized for a specific antenna. According to the above-described method, when antennas included in a single antenna group are used, an optimal tune code for a plurality of antennas 321 and 322 may be configured, instead of a tune code optimized for a specific antenna, thereby increasing the radiation performance and/or reception performance of the entire electronic device 101. Meanwhile, when the plurality of antennas are not included in a single antenna group, the electronic device 101 may control each of the plurality of tuners, based on tune codes stored corresponding to the plurality of antennas, respectively.

FIG. 6D is a diagram illustrating efficiency data according to an embodiment of the disclosure. For example, in FIG. 6D, the efficiency data may be configured as normalized radiation efficiency, but there are no limitations on the method of configuring the efficiency data as described above. The first graph 651 may represent frequency-specific efficiency data corresponding to event X and tune code A for an antenna. A first portion 653 of the efficiency data table may be configured corresponding to the first graph 651. The second graph 652 may represent frequency-specific efficiency data corresponding to event X and tune code B for the antenna. A second portion 654 of the efficiency data table may be configured corresponding to the second graph 652. As shown in FIG. 6D, the frequency gap may be configured to 50 MHz in some sections and 20 MHz in other sections. For example, the frequency gap may be variable when applying variable sampling in which the sampling interval may be changed. Meanwhile, at least some of the graphs 651 and 652 may be configured based on interpolation, but there is no limitation on the configuration method. Those skilled in the art may appreciate that the identified first portion 653 and second portion 654 of the efficiency data table may be provided to the electronic device 101 and stored and/or managed, and there are no limitations on the providing method and/or providing time.

FIG. 6E is a flowchart illustrating an operation method of an electronic device according to an embodiment of the disclosure. Meanwhile, those skilled in the art may understand that the example in FIG. 6E may be performed by an external electronic device rather than the electronic device 101.

Referring to FIG. 6E, according to an embodiment of the disclosure, the electronic device 101 may configure an event in operation 671. For example, the event may be a universal series bus (USB) connection, a travel adapter (TA) connection, and/or grip detection, but the type of event is not limited. In operation 673, the electronic device 101 may collect efficiency data for each antenna and/or frequency. For example, the electronic device 101 may collect efficiency data corresponding to a plurality of frequencies, respectively, by performing a frequency sweep for each antenna. In operation 675, the electronic device 101 may identify whether efficiency data has been collected for all events. If efficiency data has not been collected for all events (No in operation 675), the electronic device 101 may perform event configuration and/or efficiency data collection until efficiency data has been collected for all events. If efficiency data has been collected for all events (No in operation 675), the electronic device 101 may compute a tune code corresponding to a combination of a plurality of frequencies in operation 677. For example, the electronic device 101 may compute and store a tune code with maximum efficiency (or maximum radiation). For example, the electronic device 101 may compute a tune code corresponding to carrier aggregation (CA) based on frequency combinations and primary component carrier (PCC) and secondary component carrier (SCC) performance. For example, the electronic device 101, based on at least one efficiency corresponding to the first frequency of the PCC and at least one efficiency corresponding to the second frequency of the SCC, may identify a tune code in which both efficiencies have maximum values, but this is merely an example, and there are no limitations on the identification method. The electronic device 101 may store the identified tune code in operation 679. Later, if a tune code corresponding to an event, frequency, and antenna exists among the stored information, the electronic device 101 may utilize the corresponding tune code. The electronic device 101 may process and/or store efficiency data for each event, each antenna, and/or each frequency in operation 681. Depending on the implementation, the electronic device 101 may process and store the identified efficiency data or store it as raw data without processing. The electronic device 101 may store antenna group information (e.g., information as shown in Table 1) in operation 683. Later, if a tune code corresponding to an event, frequency, and antenna does not exist among the stored information, the electronic device 101 may identify an optimal tune code corresponding to the antenna group, based on the stored efficiency data. The electronic device 101 may be configured to use a default tune code based on the satisfaction of a specified condition, but is not limited thereto.

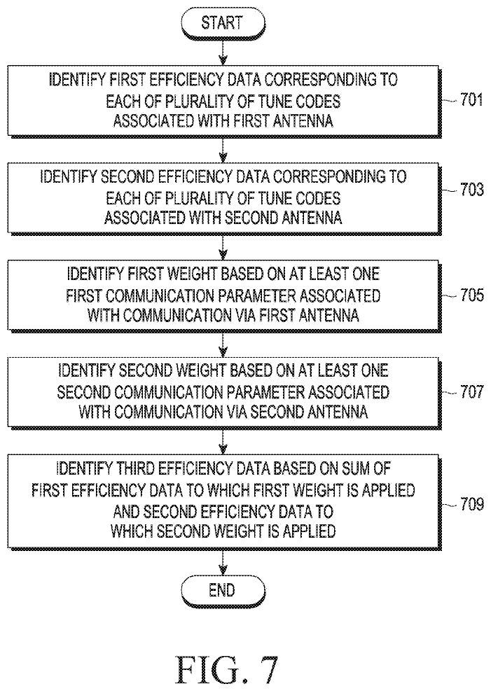

FIG. 7 is a flowchart illustrating an operation method of an electronic device according to an embodiment of the disclosure.

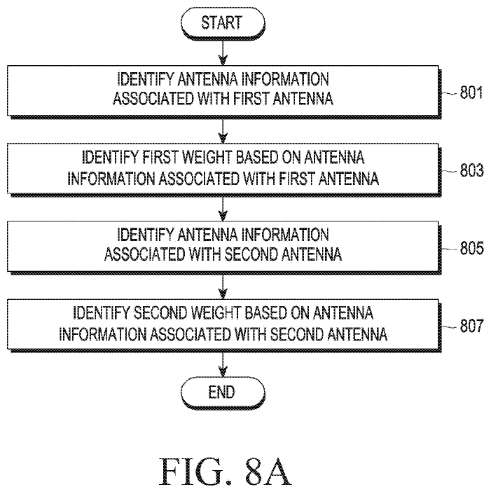

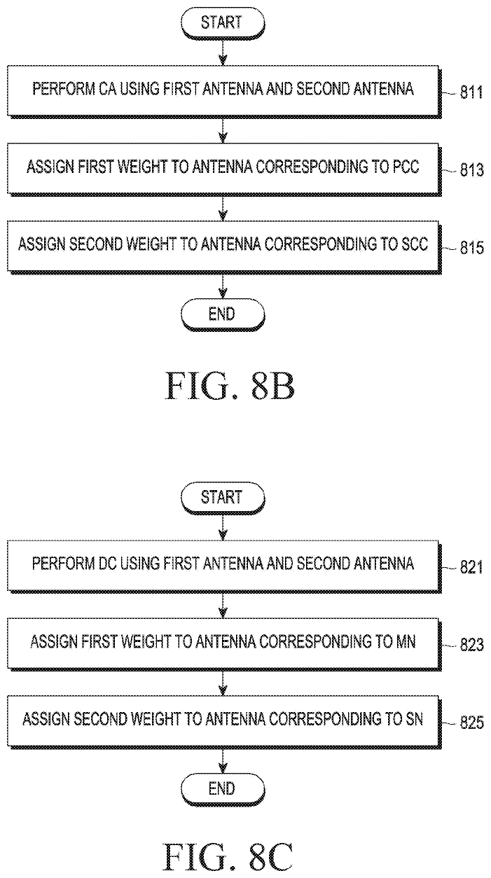

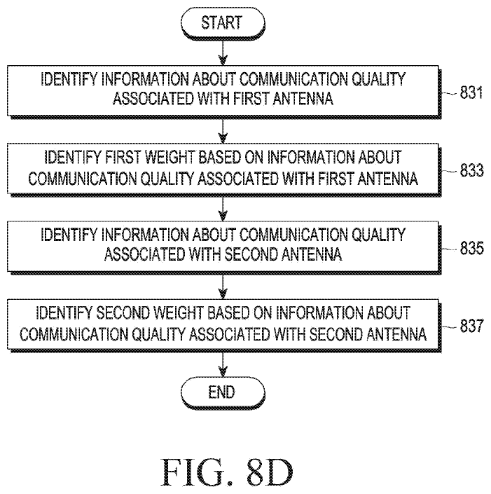

Referring to FIG. 7, according to an embodiment of the disclosure, the electronic device 101 may identify first efficiency data (e.g., 611A in FIG. 6A) corresponding to each of a plurality of tune codes associated with the first antenna 321, the first frequency, and the first event in operation 701. In operation 703, the electronic device 101 may identify second efficiency data (e.g., 622A in FIG. 6A) corresponding to each of a plurality of tune codes associated with the second antenna 322, the first frequency, and the first event. As described above, the electronic device 101 may identify the first event and configure the first antenna 321 corresponding to the first frequency and the second antenna 322 corresponding to the second frequency. In operation 705, the electronic device 101 may identify a first weight, based on at least one first communication parameter associated with communication via the first antenna 321. In operation 707, the electronic device 101 may identify a second weight, based on at least one second communication parameter associated with communication via the second antenna 322. For example, the weight may be configured based on antenna information, carrier aggregation (CA)-related information, dual connectivity (DC)-related information, and/or communication quality-related information, and each configuration method will be described with reference to FIGS. 8A, 8B, 8C, and 8D. In operation 709, the electronic device 101 may identify third efficiency data, based on the sum (weight sum) of the first efficiency data to which the first weight is applied and the second efficiency data to which the second weight is applied. For example, the electronic device 101 may identify a tune code corresponding to the maximum value among the sums of the first efficiency data to which the first weight is applied and the second efficiency data to which the second weight is applied, as the optimal tune code.

For example, Table 2 shows examples of efficiency data 611A corresponding to the first antenna 321, the first frequency, and the first event, and efficiency data 622A corresponding to the second antenna 322, the second frequency, and the first event.

TABLE 2

| | Efficiency data | Efficiency data |
|---|---|---|
| | Corresponding to First | Corresponding to First |
| | Antenna 321 at First | Antenna 321 at Second |
| Tune codes | Frequency | Frequency |
| First Tune code | E11 | E21 |
| Second Tune code | E12 | E22 |
| Third Tune code | E13 | E23 |
| Fourth Tune code | E14 | E24 |
| Fifth Tune code | E15 | E25 |
| Sixth Tune code | E16 | E26 |

For example, the electronic device 101 may assign a first weight (w1) corresponding to the first antenna 321 and a second weight (w2) corresponding to the second antenna 322. The sum of the respectively assigned weights may be, for example, as shown in Table 3.

TABLE 3

| Tune codes | Weight Sums |
|---|---|
| First Tune code | E11 · W1 + E21 · W2 |
| Second Tune code | E12 · W1 + E22 · W2 |
| Third Tune code | E13 · W1 + E23 · W2 |
| Fourth Tune code | E14 · W1 + E24 · W2 |
| Fifth Tune code | E15 · W1 + E25 · W2 |
| Sixth Tune code | E16 · W1 + E26 · W2 |

The electronic device 101 may identify the tune code corresponding to the maximum value among the weight sums as the optimal tune code. Therefore, even for the same event, the optimal tune code may vary depending on the weights (W1 and W2) for respective antennas 321 and 322.

FIG. 8A illustrates a flowchart illustrating an operation method of an electronic device according to an embodiment of the disclosure.

Referring to FIG. 8A, according to an embodiment of the disclosure, the electronic device 101, in operation 801, may identify antenna information associated with the first antenna 321. In operation 803, the electronic device 101 may identify a first weight assigned to the first antenna 321, based on the antenna information associated with the first antenna 321. In operation 805, the electronic device 101 may identify antenna information associated with the second antenna 322. In operation 807, the electronic device 101 may identify a second weight assigned to the second antenna 322, based on the antenna information associated with the second antenna 322. The antenna information may include, for example, information regarding whether the antenna is a transmitting antenna and/or information regarding whether the antenna is a receiving antenna. For example, the weight corresponding to the transmitting antenna may be configured to be greater than the weight corresponding to the receiving antenna, but this is merely exemplary and there is no limitation. The antenna information may include, for example, information regarding whether the antenna is a primary receive (PRX) antenna and/or information regarding whether the antenna is a diversity receive (DRX) antenna. For example, the weight corresponding to the PRX antenna may be configured to be greater than the weight corresponding to the DRX antenna, but this is merely exemplary and there is no limitation. The antenna information may include, for example, information related to MIMO (e.g., information regarding whether the antenna is a main antenna). For example, the weight corresponding to the main antenna may be configured to be greater than the weight corresponding to the sub antenna, but this is merely exemplary and there is no limitation.

FIG. 8B illustrates a flowchart illustrating an operation method of an electronic device according to an embodiment of the disclosure.

Referring to FIG. 8B, according to an embodiment of the disclosure, the electronic device 101, in operation 811, may identify to perform carrier aggregation (CA) using the first antenna 321 and the second antenna 322. For example, the electronic device 101 may identify that the first antenna 321 is to be used for communication of a primary component carrier (PCC) and that the second antenna 322 is to be used for communication of a secondary component carrier (SCC). The electronic device 101 may assign a first weight to an antenna (e.g., the first antenna 321) corresponding to the PCC in operation 813. The electronic device 101 may assign a second weight to an antenna (e.g., the second antenna 322) corresponding to the SCC in operation 815. For example, the first weight corresponding to the PCC may be configured to be greater than the second weight corresponding to the SCC, but this is merely exemplary and there is no limitation.

FIG. 8C illustrates a flowchart illustrating an operation method of an electronic device according to an embodiment of the disclosure.

Referring to FIG. 8C, according to an embodiment of the disclosure, the electronic device 101, in operation 821, may identify to perform DC using the first antenna 321 and the second antenna 322. For example, the electronic device 101 may identify that the first antenna 321 is to be used for communication of a master node (MN) (or master cel group (MCG)) and that the second antenna 322 is to be used for communication of a secondary node (SN) (or secondary cell group (SCG)). The electronic device 101 may assign a first weight to an antenna (e.g., the first antenna 321) corresponding to the MN in operation 823. The electronic device 101 may assign a second weight to an antenna (e.g., the second antenna 322) corresponding to the SN in operation 825. For example, the first weight corresponding to the MN may be configured to be greater than the second weight corresponding to the SN, but this is merely exemplary and there is no limitation.

FIG. 8D illustrates a flowchart illustrating an operation method of an electronic device according to an embodiment of the disclosure.

Referring to FIG. 8D, according to an embodiment of the disclosure, the electronic device 101, in operation 831, may identify information about communication quality associated with the first antenna 321. In operation 833, the electronic device 101 may identify a first weight assigned to the first antenna 321, based on the information about the communication quality associated with the first antenna 321. In operation 835, the electronic device 101 may identify information about the communication quality associated with the second antenna 322. In operation 837, the electronic device 101 may identify a second weight assigned to the second antenna 322, based on the information about the communication quality associated with the second antenna 322. The information about the communication quality may include, for example, information about bandwidth. For example, the weight corresponding to an antenna associated with a larger bandwidth may be configured to be greater than a weight corresponding to an antenna associated with a smaller bandwidth, but this is merely exemplary and there is no limitation. With regard to the information about the communication quality, those skilled in the art may appreciate that the weights may be configured based on, for example, parameters associated with communication quality (which may be reference signal received power (RSRP), reference signal received quality (RSRQ), reference signal strength (RSSI), signal-to-interference-plus-noise ratio (SINR), data rate, block error rate (BLER), data throughput, and/or channel quality index (CQI), but are not limited thereto). For example, the weight corresponding to an antenna associated with better communication quality may be configured to be greater than a weight corresponding to an antenna associated with poorer communication quality, but this is merely exemplary and there is no limitation. The information about communication quality may include, for example, information about radio access technology (RAT). For example, the weight corresponding to an antenna associated with relatively recently defined RAT may be configured to be greater, but this is merely exemplary and there is no limitation. For example, the weight corresponding to an antenna associated with new radio (NR) may be configured to be greater than the weight corresponding to an antenna associated with evolved universal mobile telecommunication system (UMTS) terrestrial radio access (E-UTRA).

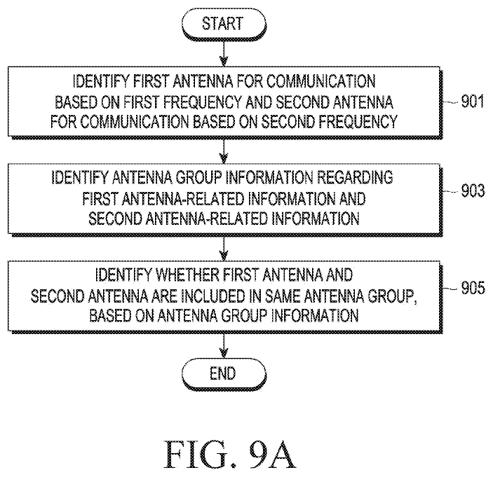

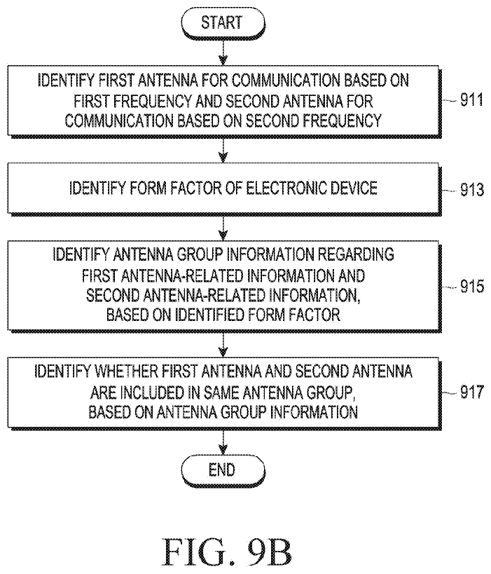

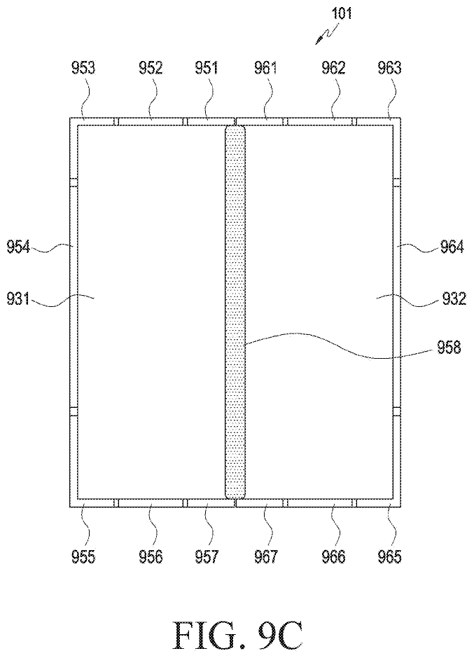

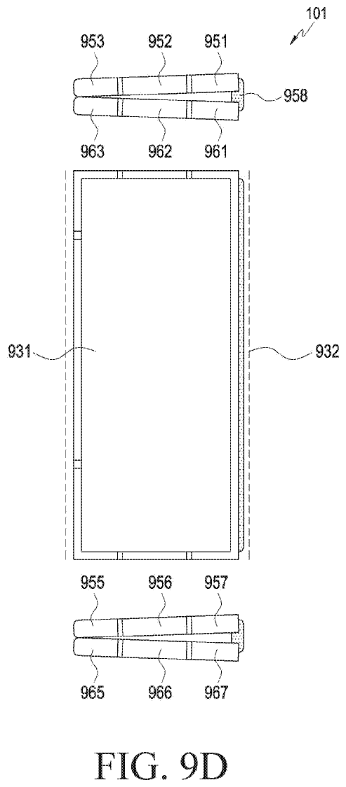

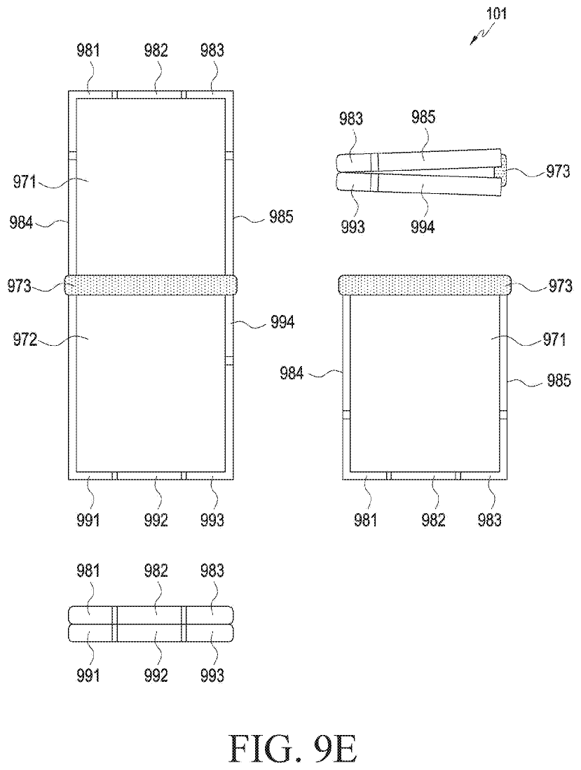

FIG. 9A illustrates a flowchart illustrating an operation method of an electronic device according to an embodiment of the disclosure.

Referring to FIG. 9A, according to an embodiment of the disclosure, in operation 901, the electronic device 101 may identify a first antenna 321 for communication based on the first frequency and a second antenna 322 for communication based on the second frequency. In operation 903, the electronic device 101 may identify antenna group information regarding first antenna-related information and second antenna-related information. In operation 905, the electronic device 101 may identify whether the first antenna and the second antenna are included in the same antenna group, based on the antenna group information. For example, the electronic device 101 may identify antenna group-related information corresponding to a plurality of antennas being used by referencing antenna group-related information as shown in Table 1. As described with reference to Table 1, the electronic device 101 may identify that the first antenna 321 and the second antenna 322 are included in a first antenna group, respectively, thereby identifying that the first antenna 321 and the second antenna 322 are included in a single antenna group. Alternatively, based on a change of the first antenna 321 to the third antenna 323 (e.g., a change based on ASDiv or antenna hopping), the electronic device 101 may identify that the third antenna 333 is included in a second antenna group. Accordingly, the electronic device 101 may also identify that the second antenna 322 and the third antenna 323 are included in different antenna groups.

FIG. 9B illustrates a flowchart illustrating an operation method of an electronic device according to an embodiment of the disclosure. The embodiment in FIG. 9B will be described with reference to FIGS. 9C, 9D, and 9E. FIGS. 9C, 9D, and 9E are diagrams illustrating changes in the form factor of an electronic device according to various embodiments of the disclosure.

Referring to FIGS. 9B and 9C, according to an embodiment of the disclosure, the electronic device 101, in operation 911, may identify a first antenna 953 for communication based on a first frequency and a second antenna 963 for communication based on a second frequency, as shown in FIG. 9C. In operation 913, the electronic device 101 may identify the form factor of the electronic device 101. According to an embodiment of the disclosure, the form factor may include information regarding the shape formed by at least one housing of the electronic device 101. For example, when the electronic device 101 is configured with at least one housing capable of being folded, the form factor may include information regarding a folded or unfolded state, without limitation. For example, as shown in FIG. 9C, antennas 951, 952, 953, 954, 955, 956, and 957 may be disposed on a first housing 931 of the electronic device 101. Antennas 961, 962, 963, 964, 965, 966, and 967 may be disposed on a second housing 932 of the electronic device 101. Here, the antennas 951, 952, 953, 954, 955, 956, and 957 and/or the antennas 961, 962, 963, 964, 965, 966, and 967 may be segmented antennas, but there is no limitation on their type. The first housing 931 and the second housing 932 may be connected to a hinge structure 958. The hinge structure 958 may include, for example, a rotatable structure. Accordingly, at least one housing may be rotated about the hinge structure 958, thereby allowing the electronic device 101 to be folded, as shown in FIG. 9D. The form factor of the electronic device 101 in FIG. 9D may be referred to as a closed state, and the form factor of the electronic device 101 in FIG. 9C may be referred to as an open state. As shown in FIG. 9C, in the open state of the form factor of the electronic device 101, the distance between the first antenna 953 and the second antenna 963 may exceed a threshold distance, and the first antenna 953 and the second antenna 963 may not be included in the same antenna group. As shown in FIG. 9D, in the closed state of the form factor of the electronic device 101, the distance between the first antenna 953 and the second antenna 963 may be less than or equal to a threshold distance, and the first antenna 953 and the second antenna 963 may be included in the same antenna group. As described above, in the electronic device 101 with a variable form factor, antennas may be included in the same antenna group or may not be included in the same antenna group, depending on the form factor.

According to an embodiment of the disclosure, referring back to FIG. 9B, the electronic device 101, in operation 915, may identify antenna group information regarding first antenna-related information and second antenna-related information, based on the identified form factor. In operation 917, the electronic device 101, based on the antenna group information, may identify whether the first antenna 953 and the second antenna 963 are included in the same antenna group. For example, the electronic device 101 may store and/or manage respective pieces of antenna group-related information, as shown in Table 1, for a plurality of form factors. For example, the electronic device 101 may store and/or manage first antenna group-related information for each antenna corresponding to the open state in FIG. 9C, and may also store and/or manage second antenna group-related information for each antenna corresponding to the open state in FIG. 9D. The electronic device 101 may reference the antenna group-related information corresponding to the identified form factor, thereby identifying whether the antennas to be used are included in the same antenna group.

Referring to FIGS. 9D and 9E, according to an embodiment of the disclosure, the electronic device 101 may be implemented to be folded in a direction different from the folding direction in FIG. 9D. For example, the electronic device 101 may include a first housing 971 and a second housing 972. Antennas 981, 982, 983, 984, and 985 may be disposed on the first housing 971, and antennas 991, 992, 993, and 994 may be disposed on the second housing 972. The first housing 971 and the second housing 972 may be connected to a hinge structure 973. The hinge structure 973 may include a rotatable structure, thereby allowing the housing to rotate around the hinge structure 973. Therefore, as shown in FIG. 9E, the first housing 971 and the second housing 972 may rotate (e.g., in an up/down direction) to face each other. For example, the form factor of the electronic device 101 may include a closed state and an open state, as shown in FIG. 9E. Meanwhile, although not shown, the form factor of the electronic device 101 may also include a half-opened state. For example, the form factor in which the angle between the housings 471 and 472 is greater than 0 degrees and less than 180 degrees may be referred to as a half-opened state, but there is no limitation. The electronic device 101 may store and/or manage antenna group-related information for each of the above-described form factors. Alternatively, the electronic device 101 may store and/or manage antenna group-related information based on the angle (or range of angles) between the housings 471 and 472. Meanwhile, the form factor changes based on the folding method shown in FIGS. 9C to 9E are merely exemplary, and those skilled in the art may understand that the electronic device 101 with a variable form factor (e.g., a rollable (or slidable) electronic device) may also store and/or manage antenna group-related information for each form factor (or each parameter associated with the form factor change).

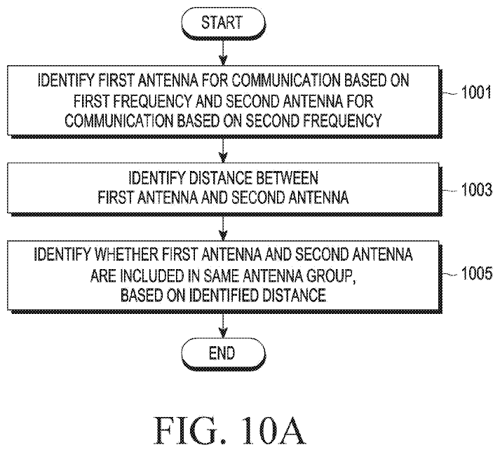

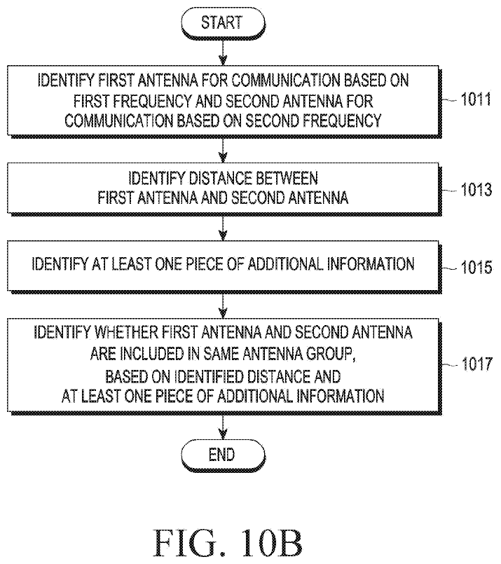

FIG. 10A illustrates a flowchart illustrating an operation method of an electronic device according to an embodiment of the disclosure.

Referring to FIG. 10A, according to an embodiment of the disclosure, the electronic device 101, in operation 1001, may identify a first antenna 321 for communication based on a first frequency and a second antenna 322 for communication based on a second frequency. The electronic device 101 may identify the distance between the first antenna 321 and the second antenna 322 in operation 1003. As described above, there are no limitations on the reference points of the antennas for defining the distance between the antennas 321 and 322. For example, the reference point may be configured in various ways, such as the point where the largest radiation signal is generated among the antennas, the center of mass of the antenna, or a point at one end of the antenna, and there are no limitations on the configuration method. The electronic device 101 may identify the distance between the reference points. The electronic device 101 may be configured to identify, for example, a pre-stored distance between the antennas or to calculate the distance based on the positions (or it may be referred to as coordinates) of the antennas. In operation 1005, the electronic device 101 may identify whether the first antenna 321 and the second antenna 322 are included in the same antenna group, based on the identified distance. For example, the electronic device 101 may identify that the antennas 321 and 322 are included in the same antenna group, based on the identified distance being less than or equal to a threshold distance. For example, the electronic device 101 may identify that the antennas 321 and 322 are included in different antenna groups, based on the identified distance exceeding a threshold distance.

For example, the electronic device 101 may identify the distance between the antennas 321 and 322, based on the current form factor. For example, the electronic device 101 may store information regarding the distance between the antennas 321 and 322 for each of a plurality of form factors. In this case, the electronic device 101 may reference the stored information to identify the distance between the antennas 321 and 322 corresponding to the current form factor. Alternatively, the electronic device 101 may also calculate the distance between the antennas 321 and 322, based on at least one parameter defining the current form factor. For example, in the case of the electronic device 101 shown in FIGS. 9C and 9D, the angle formed between the two housings 431 and 432 may be identified as at least one parameter defining the form factor. The electronic device 101 may calculate the distance between the antennas 321 and 322 using the angle formed between the two housings 431 and 432. For example, the electronic device 101 may calculate a distance, based on the positions (or coordinates) of the respective antennas 321 and 322 configured based on the angle formed between the two housings 431 and 432, but there is no limitation on the method of calculating the distance.

FIG. 10B illustrates a flowchart illustrating an operation method of an electronic device according to an embodiment of the disclosure.

Referring to FIG. 10B, according to an embodiment of the disclosure, the electronic device 101, in operation 1011, may identify a first antenna 321 for communication based on a first frequency and a second antenna 322 for communication based on a second frequency. In operation 1013, the electronic device 101 may identify the distance between the first antenna 321 and the second antenna 322. In operation 1015, the electronic device 101 may identify at least one piece of additional information. For example, the electronic device 101 may identify, as additional information, the shape of the antenna, the extension direction of the antenna, the type of the antenna, and/or the frequency characteristics of the antenna, but there is no limitation on the type and/or number of additional information. In operation 1017, the electronic device 101 may identify whether the first antenna 321 and the second antenna 322 are included in the same antenna group, based on the identified distance and at least one piece of additional information.

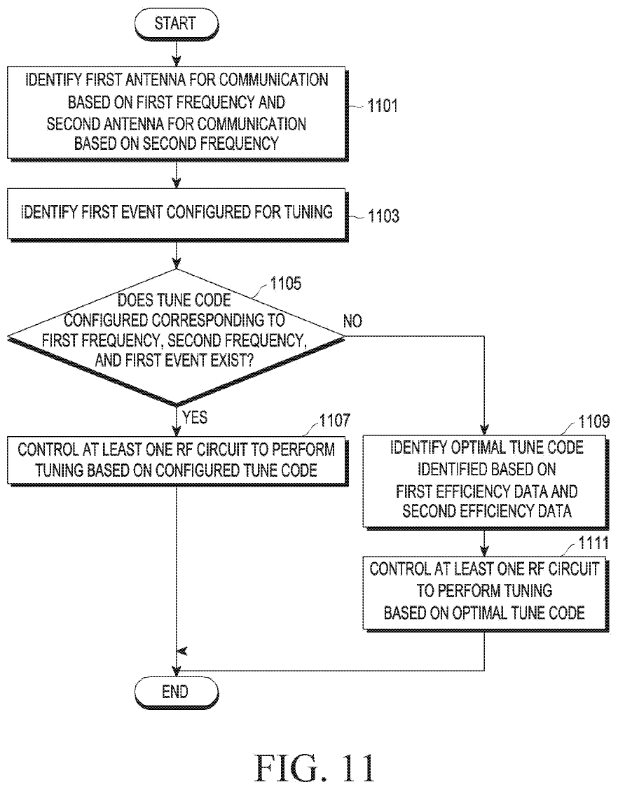

FIG. 11 illustrates a flowchart illustrating an operation method of an electronic device according to an embodiment of the disclosure.

Referring to FIG. 11, according to an embodiment of the disclosure, in operation 1101, the electronic device 101 may identify a first antenna 321 for communication based on a first frequency and a second antenna 322 for communication based on a second frequency. For example, the electronic device 101 may identify a first frequency and a second frequency (which may also be referred to as a combination of target frequencies) for carrier aggregation (CA), dual connectivity (DC), dual SIM, and/or measurement of reception strength for a serving cell and a neighbor cell. With respect to CA, for example, the frequencies corresponding to a primary component carrier (PCC) and a secondary component carrier (SCC) may be identified as the first frequency and the second frequency (or a combination of target frequencies), respectively. With respect to DC, for example, the frequencies corresponding to a master node (MN) and a secondary node (SN) may be identified as the first frequency and the second frequency (or a combination of target frequencies), respectively. With respect to dual SIM, the frequencies of the cells connected to the dual SIMs may be identified as the first frequency and the second frequency (or a combination of target frequencies), respectively. Alternatively, the frequency corresponding to the serving cell may be identified as the first frequency, and the frequency corresponding to the neighbor cell may be identified as the second frequency.

In operation 1103, the electronic device 101 may identify a first event configured for tuning. Those skilled in the art may understand that an event may also be referred to as a state, mode, or condition. In operation 1105, the electronic device 101 may identify whether a tune code configured corresponding to the first frequency associated with the first antenna 321, the second frequency associated with the second antenna 322, and the first event exists. For example, the electronic device 101 may identify whether a tune code corresponding to the first frequency and the second frequency (or a combination of target frequencies (or target bands)) and the first event is stored in the electronic device 101 in a non-volatile (NV) manner, but there are no limitations on the identification method. For example, the electronic device 101 may pre-store and/or manage a plurality of tune codes corresponding to at least one antenna, at least one frequency, and/or at least one event. The electronic device 101 may identify whether a tune code configured corresponding to the identified first frequency associated with the first antenna 321, second frequency associated with the second antenna 322, and first event exists among the plurality of tune codes. If a tune code configured corresponding to the first frequency associated with the first antenna 321, the second frequency associated with the second antenna 322, and the first event exists (Yes in operation 1105), the electronic device 101 may control at least one RF circuit to perform tuning, based on the tune code configured corresponding to the first frequency associated with the first antenna 321, the second frequency associated with the second antenna 322, and the first event in operation 1107. If a tune code configured corresponding to the first frequency associated with the first antenna 321, the second frequency associated with the second antenna 322, and the first event does not exist (No in operation 1105), the electronic device 101, in operation 1109, may identify an optimal tune code identified based on first efficiency data for each of the plurality of tune codes for the first antenna 321, the first frequency, and the first event, and second efficiency data for each of the plurality of tune codes for the second antenna 322, the second frequency, and the first event. For example, the method for identifying the optimal tune code has been described with reference to FIGS. 6A and 6C, and thus duplicate descriptions thereof will be omitted here. In operation 1111, the electronic device 101 may control at least one RF circuit to perform tuning, based on the optimal tune code. For example, as described with reference to FIGS. 4B and 4C, the electronic device 101 may control at least one RF circuit by controlling the capacitance of the capacitor 441 and/or by controlling the on/off states of the switches 422, 424, 426, 428, 442, 443, 444, and 445 so as to correspond to the identified optimal tune code. Meanwhile, the embodiment in FIG. 11 is exemplary, and the electronic device 101 may be configured to identify the optimal tune code based on efficiency data without determining whether a preconfigured tune code exists.

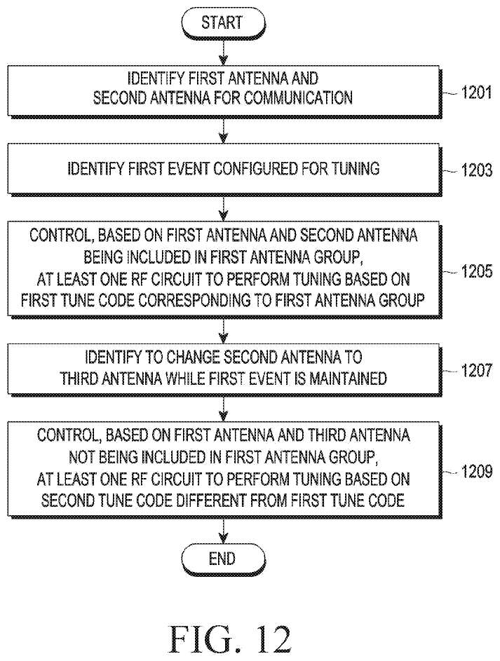

FIG. 12 illustrates a flowchart illustrating an operation method of the electronic device according to an embodiment of the disclosure.

Referring to FIG. 12, according to an embodiment of the disclosure, in operation 1201, the electronic device 101 may identify a first antenna 321 for communication based on a first frequency and a second antenna 322 for communication based on a second frequency. In operation 1203, the electronic device 101 may identify a first event configured for tuning. In operation 1205, based on the first antenna 321 and the second antenna 322 being included in a first antenna group, the electronic device 101 may control at least one RF circuit to perform tuning based on a first tune code corresponding to the first antenna group. As described above, the electronic device 101 may identify the optimal tune code, identified based on first efficiency data for each of a plurality of tune codes for the first antenna 321, the first frequency, and the first event, and second efficiency data for each of a plurality of tune codes for the second antenna 322, the second frequency, and the first event, as the tune code corresponding to the first antenna group. For example, the method for identifying the optimal tune code has been described with reference to FIGS. 6A and 6C, and thus duplicate descriptions thereof will be omitted here. Meanwhile, those skilled in the art may understand that the first tune code may be stored in the electronic device 101, for example, in an NV manner.

According to an embodiment of the disclosure, in operation 1207, the electronic device 101 may identify that the second antenna 322 is to be changed to the third antenna 323 while the first event is maintained. For example, the first antenna 321 and the third antenna 323 may be included in different antenna groups, respectively. For example, when the first event is a grip event, the antenna for communication based on the second antenna 322 may need to be changed from the second antenna 322 to the third antenna 323 while the occurrence of the grip event is maintained. As an example, if the RSRP corresponding to the third antenna 323 is greater than the RSRP corresponding to the second antenna 322 by a threshold value or more, the electronic device 101 may change the antenna for communication from the second antenna 322 to the third antenna 323. As an example, based on the predicted violation against the SAR restriction rule based on the cumulative value (or average value) of the SAR generated based on the first antenna 321 and the second antenna 322, the electronic device 101 may change the antenna for communication from the second antenna 322 to the third antenna 323. For example, according to conditions based on the sum-peak location separation ratio (SPLSR) by the federal communications commission (FCC), whether the first antenna 321 and the second antenna 322 violate the restriction rules may be determined based on the sum of the SARs, and whether the first antenna 321 and the third antenna 323 violate the restriction rules may be determined based on their respective SARs. Meanwhile, there are no limitations on the conditions under which the antenna for communication is changed from the second antenna 322 to the third antenna 323. According to an embodiment of the disclosure, in operation 1209, based on the first antenna 321 and the third antenna 323 not being included in a single antenna group, the electronic device 101 may control a tuner for the first antenna 321 included in at least one RF circuit to perform tuning based on a second tune code different from the first tune code. For example, the electronic device 101 may pre-store and/or manage the second tune code corresponding to the first event and the first frequency. The electronic device 101 may identify the second tune code stored and/or managed corresponding to the first event and the first frequency, and control the tuner for the first antenna 321, based on the second tune code. The second tune code may correspond to, for example, the first antenna 321, but depending on the implementation, it may be configured not to correspond to the first antenna 321 (e.g., to correspond to any antenna or not to have antenna dependency). Meanwhile, the electronic device 101 may also control the tuner corresponding to the third antenna 323, based on a third tune code corresponding to the first event and the second frequency. As described above, even if the first event is maintained, the tune code of the tuner corresponding to the first antenna 321 may be configured to the first tune code when the second antenna 322 is used together, and may be configured to the second tune code when the third antenna 323 is used together.

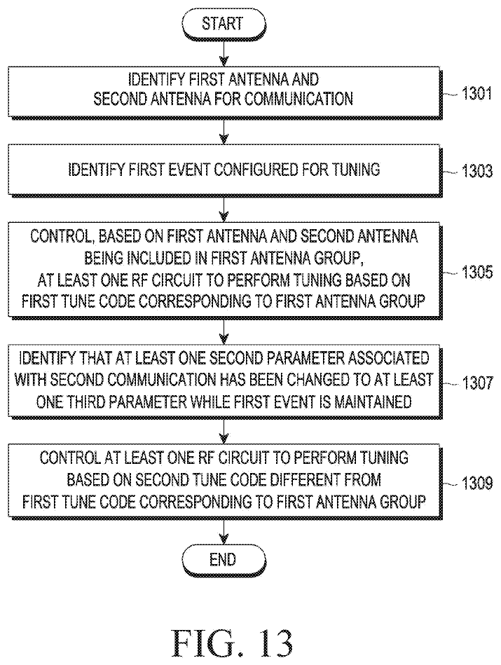

FIG. 13 illustrates a flowchart illustrating an operation method of an electronic device according to an embodiment of the disclosure.

Referring to FIG. 13, according to an embodiment of the disclosure, in operation 1301, the electronic device 101 may identify a first antenna 321 for communication based on a first frequency and a second antenna 322 for communication based on a second frequency. In operation 1303, the electronic device 101 may identify a first event configured for tuning. In operation 1305, based on the first antenna 321 and the second antenna 322 being included in a first antenna group, the electronic device 101 may control at least one RF circuit to perform tuning based on a first tune code corresponding to the first antenna group. As described above, the electronic device 101 may identify the optimal tune code, identified based on first efficiency data for each of a plurality of tune codes for the first antenna 321, the first frequency, and the first event, and second efficiency data for each of a plurality of tune codes for the second antenna 322, the second frequency, and the first event, as the tune code corresponding to the first antenna group. For example, the electronic device 101, based on identifying at least one first parameter corresponding to the first antenna 321 at a first time point, may assign a 1-1st weight (W11) corresponding to the first parameter to the first antenna 321. For example, the electronic device 101, based on the identifying at least one second parameter corresponding to the second antenna 322 at the first time point, may assign a 1-2nd weight (W12) corresponding to the second parameter to the second antenna 322. Accordingly, the electronic device 101 may identify the weight sum as shown in Table 4.

TABLE 4

| Tune codes | Weight Sums |
|---|---|
| First Tune code | E11 · W11 + E21 · W12 |
| Second Tune code | E12 · W11 + E22 · W12 |
| Third Tune code | E13 · W11 + E23 · W12 |
| Fourth Tune code | E14 · W11 + E24 · W12 |
| Fifth Tune code | E15 · W11 + E25 · W12 |
| Sixth Tune code | E16 · W11 + E26 · W12 |

For example, the electronic device 101 may identify the first tune code, which is the maximum value among the weight sums according to Table 4, as the optimal tune code. In operation 1307, the electronic device 101 may identify that, while the first event is maintained, at least one second parameter associated with the second communication has been changed to at least one third parameter. For example, while the first event of “free-space” is maintained, for example, while a state in which no other object is in contact with the electronic device 101 is maintained, the parameter associated with the second communication may be changed. For example, while the first event of “grip” is maintained, for example, while a sensing value indicating whether the electronic device 101 is gripped by a user remains unchanged, the parameter associated with the second communication may be changed. In operation 1309, the electronic device 101 may control at least one RF circuit to perform tuning based on a second tune code that is different from the first tune code corresponding to the first antenna group. For example, based on identifying at least one first parameter corresponding to the first antenna 321 at a second time point, the electronic device 101 may assign a 1-1st weight (W11) corresponding to the first parameter to the first antenna 321. For example, although it is assumed that at least one first parameter remains unchanged, it is exemplary, and those skilled in the art may understand that at least one first parameter may also be changed at least in part. For example, based on identifying at least one third parameter corresponding to the second antenna 322 at a second time point, the electronic device 101 may assign a 2-3rd weight (W23) corresponding to the second parameter to the second antenna 322. Accordingly, the electronic device 101 may identify the weight sums as shown in Table 5.

TABLE 5

| Tune codes | Weight Sums |
|---|---|
| First Tune code | E11 · W11 + E21 · W23 |
| Second Tune code | E12 · W11 + E22 · W23 |
| Third Tune code | E13 · W11 + E23 · W23 |
| Fourth Tune code | E14 · W11 + E24 · W23 |
| Fifth Tune code | E15 · W11 + E25 · W23 |
| Sixth Tune code | E16 · W11 + E26 · W23 |

For example, the electronic device 101 may identify the second tune code, which is the maximum value among the weight sums according to Table 5, as the optimal tune code. As described above, even if the first event is maintained, the optimal tune code may change as the parameter corresponding to the second antenna 322 changes. Meanwhile, the first tune code and/or the second tune code may be stored in the electronic device 101, for example, in an NV manner, or may be identified based on efficiency data as described above.

According to an embodiment of the disclosure, an electronic device 101 may include a plurality of antennas 242, 244, 248; 321, 322, 333, 334, 335, 336. The electronic device 101 may include at least one RF circuit 222, 224, 226, 228, 232, 234, 236, 238; 303, 305, 307, 309, 311, 313 connected to the plurality of antennas 242, 244, 248; 321, 322, 333, 334, 335, 336. The electronic device 101 may include at least one processor. The electronic device 101 may include memory 130 configured to store at least one instruction. The at least one instruction, when executed by at least a portion of the at least one processor, may cause the electronic device 101 to identify a first antenna for communication based on a first frequency and a second antenna for communication based on a second frequency from among the plurality of antennas 242, 244, 248; 321, 322, 333, 334, 335, 336. The at least one instruction, when executed by at least a portion of the at least one processor, may cause the electronic device 101 to identify a first event configured for tuning based on at least one tuner included in the at least one RF circuit 222, 224, 226, 228, 232, 234, 236, 238; 303, 305, 307, 309, 311, 313. The at least one instruction, when executed by at least a portion of the at least one processor, may cause the electronic device 101 to identify, based on the first antenna and the second antenna being included in a first antenna group, first efficiency data corresponding to each of a plurality of tune codes associated with the first antenna. The first efficiency data may be configured for the first event and the first frequency. The at least one instruction, when executed by at least a portion of the at least one processor, may cause the electronic device 101 to identify second efficiency data corresponding to each of a plurality of tune codes associated with the second antenna. The second efficiency data may be configured for the first event and the second frequency. The at least one instruction, when executed by at least a portion of the at least one processor, may cause the electronic device 101 to identify third efficiency data for each of a plurality of tune codes corresponding to the first antenna group, based on the first efficiency data and the second efficiency data. The at least one instruction, when executed by at least a portion of the at least one processor, may cause the electronic device 101 to identify an optimal tune code corresponding to the first antenna group, based on the third efficiency data. The at least one instruction, when executed by at least a portion of the at least one processor, may cause the electronic device 101 to control at least a portion of the at least one tuner to perform tuning based on the optimal tune code.

According to an embodiment of the disclosure, the at least one instruction, when executed by at least a portion of the at least one processor, may cause the electronic device 101 to identify, as at least part of an operation of identifying the third efficiency data, the third efficiency data, based on a sum of the first efficiency data to which a first weight is applied and the second efficiency data to which a second weight is applied.

According to an embodiment of the disclosure, the first weight may be identified based on at least one communication parameter associated with communication via the first antenna based on the first frequency. The second weight may be identified based on at least one communication parameter associated with communication via the second antenna based on the second frequency.

According to an embodiment of the disclosure, the at least one communication parameter may include information regarding whether the antenna is a transmitting antenna, information regarding whether the antenna is a receiving antenna, information regarding whether the antenna is a PRX antenna, information regarding whether the antenna is a DRX antenna, and/or information related to MIMO.

According to an embodiment of the disclosure, the at least one communication parameter may include information regarding whether it is a PCC of CA, and/or information regarding whether it is an SCC of CA.

According to an embodiment of the disclosure, the at least one communication parameter may include information regarding whether it is an MN of DC, and/or information regarding whether it is an SN of DC.

According to an embodiment of the disclosure, the at least one communication parameter may include information about a bandwidth, a parameter associated with communication quality, and/or information about RAT.

According to an embodiment of the disclosure, the at least one instruction, when executed by at least a portion of the at least one processor, may cause the electronic device 101 to identify information indicating that the first antenna and the second antenna are included in the first antenna group.

According to an embodiment of the disclosure, the at least one instruction, when executed by at least a portion of the at least one processor, may cause the electronic device 101 to identify information indicating that the first antenna and the second antenna corresponding to a current form factor of the electronic device 101 are included in the first antenna group.

According to an embodiment of the disclosure, the at least one instruction, when executed by at least a portion of the at least one processor, may cause the electronic device 101 to identify that the first antenna and the second antenna are included in the first antenna group, based on a distance between the first antenna and the second antenna being less than a threshold distance.

According to an embodiment of the disclosure, an operation method of an electronic device 101 may include identifying a first antenna for communication based on a first frequency and a second antenna for communication based on a second frequency from among a plurality of antennas 242, 244, 248; 321, 322, 333, 334, 335, 336 of the electronic device 101. The operation method of an electronic device 101 may include identifying a first event configured for tuning based on at least one tuner included in at least one RF circuit 222, 224, 226, 228, 232, 234, 236, 238; 303, 305, 307, 309, 311, 313 of the electronic device 101. The operation method of an electronic device 101 may include identifying, based on the first antenna and the second antenna being included in a first antenna group, first efficiency data corresponding to each of a plurality of tune codes associated with the first antenna. The first efficiency data may be configured for the first event and the first frequency. The operation method of an electronic device 101 may include identifying second efficiency data corresponding to each of a plurality of tune codes associated with the second antenna. The second efficiency data may be configured for the first event and the second frequency. The operation method of an electronic device 101 may include identifying third efficiency data for each of a plurality of tune codes corresponding to the first antenna group, based on the first efficiency data and the second efficiency data. The operation method of an electronic device 101 may include identifying an optimal tune code corresponding to the first antenna group, based on the third efficiency data. The operation method of an electronic device 101 may include controlling at least a portion of the at least one tuner to perform tuning based on the optimal tune code.

According to an embodiment of the disclosure, in the identifying of the third efficiency data, the third efficiency data may be identified based on a sum of the first efficiency data to which a first weight is applied and the second efficiency data to which a second weight is applied.

According to an embodiment of the disclosure, the first weight may be identified based on at least one communication parameter associated with communication via the first antenna based on the first frequency. The second weight may be identified based on at least one communication parameter associated with communication via the second antenna based on the second frequency.

According to an embodiment of the disclosure, the at least one communication parameter may include information regarding whether the antenna is a transmitting antenna, information regarding whether the antenna is a receiving antenna, information regarding whether the antenna is a PRX antenna, information regarding whether the antenna is a DRX antenna, and/or information related to MIMO.

According to an embodiment of the disclosure, the at least one communication parameter may include information regarding whether it is a PCC of CA, and/or information regarding whether it is an SCC of CA.

According to an embodiment of the disclosure, the at least one communication parameter may include information regarding whether it is an MN of DC, and/or information regarding whether it is an SN of DC.

According to an embodiment of the disclosure, the at least one communication parameter may include information about a bandwidth, a parameter associated with communication quality, and/or information about RAT.

According to an embodiment of the disclosure, the operation method of an electronic device may further include identifying information indicating that the first antenna and the second antenna are included in the first antenna group.

According to an embodiment of the disclosure, the identifying of the information indicating that the first antenna and the second antenna are included in the first antenna group may include identifying information indicating that the first antenna and the second antenna corresponding to a current form factor of the electronic device 101 are included in the first antenna group.

According to an embodiment of the disclosure, the identifying of the information indicating that the first antenna and the second antenna are included in the first antenna group may include identifying that the first antenna and the second antenna are included in the first antenna group, based on a distance between the first antenna and the second antenna being less than a threshold distance.

According to an embodiment of the disclosure, there is provided a computer-readable storage medium configured to store at least one instruction. The at least one instruction, when executed by at least one processor of an electronic device 101, may cause the electronic device 101 to perform at least one operation. The at least one operation may include identifying a first antenna for communication based on a first frequency and a second antenna for communication based on a second frequency from among a plurality of antennas 242, 244, 248; 321, 322, 333, 334, 335, 336 of the electronic device 101. The at least one operation may include identifying a first event configured for tuning based on at least one tuner included in at least one RF circuit 222, 224, 226, 228, 232, 234, 236, 238; 303, 305, 307, 309, 311, 313 of the electronic device 101. The at least one operation may include identifying, based on the first antenna and the second antenna being included in a first antenna group, first efficiency data corresponding to each of a plurality of tune codes associated with the first antenna. The first efficiency data may be configured for the first event and the first frequency. The at least one operation may include identifying second efficiency data corresponding to each of a plurality of tune codes associated with the second antenna. The second efficiency data may be configured for the first event and the second frequency. The at least one operation may include identifying third efficiency data for each of a plurality of tune codes corresponding to the first antenna group, based on the first efficiency data and the second efficiency data. The at least one operation may include identifying an optimal tune code corresponding to the first antenna group, based on the third efficiency data. The at least one operation may include controlling at least a portion of the at least one tuner to perform tuning based on the optimal tune code.

According to an embodiment of the disclosure, an electronic device 101 may include a plurality of antennas 242, 244, 248; 321, 322, 333, 334, 335, 336. The electronic device 101 may include at least one RF circuit 222, 224, 226, 228, 232, 234, 236, 238; 303, 305, 307, 309, 311, 313 connected to the plurality of antennas 242, 244, 248; 321, 322, 333, 334, 335, 336. The electronic device 101 may include at least one processor. The electronic device 101 may include memory 130 configured to store at least one instruction. The at least one instruction, when executed by at least a portion of the at least one processor, may cause the electronic device 101 to identify a first antenna and a second antenna for communication from the plurality of antennas 242, 244, 248; 321, 322, 333, 334, 335, 336. The at least one instruction, when executed by at least a portion of the at least one processor, may cause the electronic device 101 to identify a first event configured for tuning based on at least one tuner included in the at least one RF circuit 222, 224, 226, 228, 232, 234, 236, 238; 303, 305, 307, 309, 311, 313. The at least one instruction, when executed by at least a portion of the at least one processor, may cause the electronic device 101 to control, based on the first antenna and the second antenna being included in a first antenna group, at least a portion of the at least one tuner to perform tuning based on a first tune code corresponding to the first antenna group. The at least one instruction, when executed by at least a portion of the at least one processor, may cause the electronic device 101 to identify to change the second antenna to a third antenna while the first event is maintained. The at least one instruction, when executed by at least a portion of the at least one processor, may cause the electronic device 101 to control, based on the first antenna and the third antenna not being included in one antenna group, the at least one RF circuit 222, 224, 226, 228, 232, 234, 236, 238; 303, 305, 307, 309, 311, 313 to perform tuning based on a second tune code different from the first tune code.

According to an embodiment of the disclosure, an operation method of an electronic device 101 may include identifying a first antenna and a second antenna for communication from a plurality of antennas 242, 244, 248; 321, 322, 333, 334, 335, 336 of the electronic device 101. The operation method of an electronic device 101 may include identifying a first event configured for tuning based on at least one tuner included in at least one RF circuit 222, 224, 226, 228, 232, 234, 236, 238; 303, 305, 307, 309, 311, 313 of the electronic device 101. The operation method of an electronic device 101 may include controlling, based on the first antenna and the second antenna being included in a first antenna group, at least a portion of the at least one tuner to perform tuning based on a first tune code corresponding to the first antenna group. The operation method of an electronic device 101 may include identifying to change the second antenna to a third antenna while the first event is maintained. The operation method of an electronic device 101 may include controlling, based on the first antenna and the third antenna not being included in one antenna group, the at least one RF circuit 222, 224, 226, 228, 232, 234, 236, 238; 303, 305, 307, 309, 311, 313 to perform tuning based on a second tune code different from the first tune code.

According to an embodiment of the disclosure, an electronic device 101 may include a plurality of antennas 242, 244, 248; 321, 322, 333, 334, 335, 336. The electronic device 101 may include at least one RF circuit 222, 224, 226, 228, 232, 234, 236, 238; 303, 305, 307, 309, 311, 313 connected to the plurality of antennas 242, 244, 248; 321, 322, 333, 334, 335, 336. The electronic device 101 may include at least one processor. The electronic device 101 may include memory 130 configured to store at least one instruction. The at least one instruction, when executed by at least a portion of the at least one processor, may cause the electronic device 101 to identify a first antenna for first communication based on a first frequency and a second antenna for second communication based on a second frequency from the plurality of antennas 242, 244, 248; 321, 322, 333, 334, 335, 336. The at least one instruction, when executed by at least a portion of the at least one processor, may cause the electronic device 101 to identify a first event configured for tuning based on at least one tuner included in the at least one RF circuit 222, 224, 226, 228, 232, 234, 236, 238; 303, 305, 307, 309, 311, 313. The at least one instruction, when executed by at least a portion of the at least one processor, may cause the electronic device 101 to control, based on the first antenna and the second antenna being included in a first antenna group, at least a portion of the at least one tuner to perform tuning based on a first tune code corresponding to the first antenna group. The first tune code may correspond to at least one first parameter associated with the first communication and at least one second parameter associated with the second communication. The at least one instruction, when executed by at least a portion of the at least one processor, may cause the electronic device 101 to identify that the at least one second parameter associated with the second communication has been changed to at least one third parameter while the first event is maintained. The at least one instruction, when executed by at least a portion of the at least one processor, may cause the electronic device 101 to control at least a portion of the at least one tuner to perform tuning based on a second tune code different from the first tune code corresponding to the first antenna group. The second tune code may correspond to at least one first parameter associated with the first communication and at least one third parameter associated with the second communication.

According to an embodiment of the disclosure, an operation method of an electronic device 101 may include identifying a first antenna for first communication based on a first frequency and a second antenna for second communication based on a second frequency from a plurality of antennas 242, 244, 248; 321, 322, 333, 334, 335, 336 of the electronic device 101. The operation method of an electronic device may include identifying a first event configured for tuning based on at least one tuner included in at least one RF circuit 222, 224, 226, 228, 232, 234, 236, 238; 303, 305, 307, 309, 311, 313 of the electronic device 101. The operation method of an electronic device 101 may include controlling, based on the first antenna and the second antenna being included in a first antenna group, at least a portion of the at least one tuner to perform tuning based on a first tune code corresponding to the first antenna group. The first tune code may correspond to at least one first parameter associated with the first communication and at least one second parameter associated with the second communication. The operation method of an electronic device 101 may include identifying that the at least one second parameter associated with the second communication has been changed to at least one third parameter while the first event is maintained. The operation method of an electronic device 101 may include controlling at least a portion of the at least one tuner to perform tuning based on a second tune code different from the first tune code corresponding to the first antenna group. In the operation method of an electronic device 101, the second tune code may correspond to at least one first parameter associated with the first communication and at least one third parameter associated with the second communication.

According to an embodiment of the disclosure, there is provided a computer-readable storage medium configured to store at least one instruction. The at least one instruction, when executed by at least one processor of an electronic device 101, may cause the electronic device 101 to perform at least one operation. The at least one operation may include identifying a first antenna for first communication based on a first frequency and a second antenna for second communication based on a second frequency from a plurality of antennas 242, 244, 248; 321, 322, 333, 334, 335, 336 of the electronic device 101. The at least one operation may include identifying a first event configured for tuning based on at least one tuner included in at least one RF circuit 222, 224, 226, 228, 232, 234, 236, 238; 303, 305, 307, 309, 311, 313 of the electronic device 101. The at least one operation may include controlling, based on the first antenna and the second antenna being included in a first antenna group, at least a portion of the at least one tuner to perform tuning based on a first tune code corresponding to the first antenna group. The first tune code may correspond to at least one first parameter associated with the first communication and at least one second parameter associated with the second communication. The at least one operation may include identifying that the at least one second parameter associated with the second communication has been changed to at least one third parameter while the first event is maintained. The at least one operation may include controlling at least a portion of the at least one tuner to perform tuning based on a second tune code different from the first tune code corresponding to the first antenna group. In the at least one operation, the second tune code may correspond to at least one first parameter associated with the first communication and at least one third parameter associated with the second communication.

The electronic device according to embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments of the disclosure, each component (e.g., a module or a program) of the above-described components may include a single entity or multiple entities, and some of the multiple entities may be separately disposed in different components. According to embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a plurality of antennas;
at least one radio frequency (RF) circuit connected to the plurality of antennas;
memory, comprising one or more storage media, storing instructions; and
at least one processor communicatively coupled to the at least one RF circuit and the memory,
wherein the instructions, when executed by the at least one processor individually or collectively, cause the electronic device to:
identify a first antenna for communication based on a first frequency and a second antenna for communication based on a second frequency from among the plurality of antennas,
identify a first event configured for tuning based on at least one tuner included in the at least one RF circuit,
based on the first antenna and the second antenna being included in a first antenna group:
identify first efficiency data corresponding to each of a plurality of tune codes associated with the first antenna, the first efficiency data being configured for the first event and the first frequency, and
identify second efficiency data corresponding to each of a plurality of tune codes associated with the second antenna, the second efficiency data being configured for the first event and the second frequency,
identify third efficiency data for each of a plurality of tune codes corresponding to the first antenna group, based on the first efficiency data and the second efficiency data,
identify an optimal tune code corresponding to the first antenna group, based on the third efficiency data, and
control at least a portion of the at least one tuner to perform tuning based on the optimal tune code.

2. The electronic device of claim 1, wherein the instructions, when executed by the at least one processor individually or collectively, further cause the electronic device to:
identify, as at least part of an operation of identifying the third efficiency data, the third efficiency data, based on a sum of the first efficiency data to which a first weight is applied and the second efficiency data to which a second weight is applied.

3. The electronic device of claim 2,
wherein the first weight is identified based on at least one communication parameter associated with communication via the first antenna based on the first frequency, and
wherein the second weight is identified based on at least one communication parameter associated with communication via the second antenna based on the second frequency.

4. The electronic device of claim 3, wherein the at least one communication parameter comprises at least one of information regarding whether the first antenna is a transmitting antenna, information regarding whether the first antenna is a receiving antenna, information regarding whether the first antenna is a primary receive (PRX) antenna, information regarding whether the first antenna is a diversity receive (DRX) antenna, or information related to multiple input-multiple output (MIMO).

5. The electronic device of claim 4, wherein the at least one communication parameter comprises at least one of information regarding whether it is a primary component carrier (PCC) of carrier aggregation (CA), or information regarding whether it is an secondary component carrier (SCC) of CA.

6. The electronic device of claim 5, wherein the at least one communication parameter comprises at least one of information regarding whether it is an master node (MN) of dual connectivity (DC), or information regarding whether it is an secondary node (SN) of DC.

7. The electronic device of claim 6, wherein the at least one communication parameter comprises at least one of information about a bandwidth, a parameter associated with communication quality, or information about radio access technology (RAT).

8. The electronic device of claim 1, wherein the instructions, when executed by the at least one processor individually or collectively, further cause the electronic device to:
identify information indicating that the first antenna and the second antenna are included in the first antenna group.

9. The electronic device of claim 1, wherein the instructions, when executed by the at least one processor individually or collectively, further cause the electronic device to:
identify information indicating that the first antenna and the second antenna corresponding to a current form factor of the electronic device are included in the first antenna group.

10. The electronic device of claim 1, wherein the instructions, when executed by the at least one processor individually or collectively, further cause the electronic device to:
identify that the first antenna and the second antenna are included in the first antenna group, based on a distance between the first antenna and the second antenna being less than a threshold distance.

11. A method of operating an electronic device, the method comprising:
identifying a first antenna for communication based on a first frequency and a second antenna for communication based on a second frequency from among a plurality of antennas of the electronic device;
identifying a first event configured for tuning based on at least one tuner included in at least one radio frequency (RF) circuit of the electronic device;
based on the first antenna and the second antenna being included in a first antenna group:
identifying first efficiency data corresponding to each of a plurality of tune codes associated with the first antenna, the first efficiency data being configured for the first event and the first frequency, and
identifying second efficiency data corresponding to each of a plurality of tune codes associated with the second antenna, the second efficiency data being configured for the first event and the second frequency;
identifying third efficiency data for each of a plurality of tune codes corresponding to the first antenna group, based on the first efficiency data and the second efficiency data;
identifying an optimal tune code corresponding to the first antenna group, based on the third efficiency data; and
controlling at least a portion of the at least one tuner to perform tuning based on the optimal tune code.

12. The method of claim 11, further comprising:
identifying, as at least part of an operation of identifying the third efficiency data, the third efficiency data, based on a sum of the first efficiency data to which a first weight is applied and the second efficiency data to which a second weight is applied.

13. The method of claim 12,
wherein the first weight is identified based on at least one communication parameter associated with communication via the first antenna based on the first frequency, and
wherein the second weight is identified based on at least one communication parameter associated with communication via the second antenna based on the second frequency.

14. The method of claim 13, wherein the at least one communication parameter comprises at least one of information regarding whether the first antenna is a transmitting antenna, information regarding whether the first antenna is a receiving antenna, information regarding whether the first antenna is a primary receive (PRX) antenna, information regarding whether the first antenna is a diversity receive (DRX) antenna, or information related to multiple input-multiple output (MIMO).

15. The method of claim 13, wherein the at least one communication parameter comprises at least one of information regarding whether it is a primary component carrier (PCC) of carrier aggregation (CA), or information regarding whether it is an secondary component carrier (SCC) of CA.

16. The method of claim 15, wherein the at least one communication parameter comprises at least one of information regarding whether it is an master node (MN) of dual connectivity (DC), or information regarding whether it is an secondary node (SN) of DC.

17. The method of claim 16, wherein the at least one communication parameter comprises at least one of information about a bandwidth, a parameter associated with communication quality, or information about radio access technology (RAT).

18. The method of claim 11, further comprising:
identifying information indicating that the first antenna and the second antenna are included in the first antenna group.

19. One or more non-transitory computer-readable storage media storing one or more computer programs including computer-executable instructions that, when executed by one or more processors of an electronic device individually or collectively, cause the electronic device to perform operations, the operations comprising:
identifying a first antenna for communication based on a first frequency and a second antenna for communication based on a second frequency from among a plurality of antennas of the electronic device;
identifying a first event configured for tuning based on at least one tuner included in at least one radio frequency (RF) circuit of the electronic device;
based on the first antenna and the second antenna being included in a first antenna group:
identifying first efficiency data corresponding to each of a plurality of tune codes associated with the first antenna, the first efficiency data being configured for the first event and the first frequency, and
identifying second efficiency data corresponding to each of a plurality of tune codes associated with the second antenna, the second efficiency data being configured for the first event and the second frequency;
identifying third efficiency data for each of a plurality of tune codes corresponding to the first antenna group, based on the first efficiency data and the second efficiency data;
identifying an optimal tune code corresponding to the first antenna group, based on the third efficiency data; and
controlling at least a portion of the at least one tuner to perform tuning based on the optimal tune code.

20. The one or more non-transitory computer-readable storage media of claim 19, the operations further comprising:
identifying, as at least part of an operation of identifying the third efficiency data, the third efficiency data, based on a sum of the first efficiency data to which a first weight is applied and the second efficiency data to which a second weight is applied.
